(19) United States
(12) Patent Application Publication
(10) Pub. No.: US 2024/0053371 A1
(43) Pub. Date: Feb. 15, 2024

(54) HEATED DEGASSING DISPENSER AND METHODS

(71) Applicant: Beckman Coulter, Inc., Brea, CA (US)

(72) Inventors: Christopher R. Knutson, Chanhassen, MN (US); Kevin L. NOWAK, Waconia, MN (US); Jon P. LINDQUIST, Jr., Coon Rapids, MN (US); Gamachu MELKAMU, Minneapolis, MN (US); Glenn A. DAVIS, Taylors Falls, MN (US)

(73) Assignee: Beckman Coulter, Inc., Brea, CA (US)

(21) Appl. No.: 18/259,997

(22) PCT Filed: Dec. 31, 2021
(86) PCT No.: PCT/US2021/065852

§ 371 Date: Jun. 29, 2023

Related U.S. Application Data
(60) Provisional application No. 63/133,237, filed on Dec. 31, 2020.

(51) Int. Cl. G01N 35/10

(52) U.S. Cl. CPC G01N 35/1002

(57) ABSTRACT

Disclosed are dispensers (100, 200, 300) and methods for dispensing and degassing a liquid (102). The dispensers and methods may include a heater (308) and a first tube (124, 502) constructed of a first material. The first tube may include a first end (124A) operable to be connected to a source (104) of the liquid and a second end (124B). The first tube may be connected to the heater via a conductive pathway thermally connecting the heater to the first tube. The first material may have a permeability such that a portion of the gas dissolved in the liquid passes through the first material to an atmosphere upon being degassed from a portion of the liquid within the first tube (124, 502).

### PRIORITY CLAIM

This application claims the benefit of priority to U.S. Provisional Application No. 63/133,237, entitled “Heated Dispenser with Degasser and Methods,” filed on Dec. 31, 2020, the contents of which are hereby incorporated by reference in their entirety.

### FIELD OF THE DISCLOSURE

The present disclosure relates generally to liquid dispensing systems. More specifically, the present disclosure relates to liquid dispensing systems with heating and degassing elements and use thereof.

### BACKGROUND

Automated analyzers are commonly used in immunoassay biological sampling and analyzing applications. Automated analytical equipment, such as automated analytical immunoassay instruments can efficiently perform clinical analysis on a large number of samples, with multiple tests being run concurrently or within short time intervals. Efficiencies result, in part, because of the use of automated sample identification and tracking. This equipment can automatically prepare appropriate volume samples and can automatically set the test conditions needed to perform the scheduled tests. Test conditions can be independently established and tracked for different testing protocols simultaneously in process within a single analyzer, facilitating the simultaneous execution of a number of different tests based on different processes. Automatic handling and tracking of samples significantly reduces the potential for human error or accidents that can lead to either erroneous test results or undesirable contamination.

New substrates with improved characteristics have been developed for such automated analytical immunoassay instruments. However, substrate performance can be sensitive to dissolved gasses. Substrate performance can be sensitive to dissolve oxygen within the substrate. Substrate performance can further be sensitive to maintaining a predetermined temperature when dispensed into a reaction vessel of an automated analytical immunoassay instrument.

There is a need for a substrate dispenser that can control both the temperature and the dissolved oxygen (dO₂) concentration of the substrate when dispensed into the reaction vessel. This can include controlling both the temperature and the dissolved oxygen concentrations for different ambient temperatures as well as different ambient pressures, which may result from use of the systems and methods disclosed herein at different elevations and/or atmospheric pressure conditions caused by weather.

There is a need for a substrate dispenser that can heat the substrate to a controlled temperature and degas the substrate to a desired level over a wide range of ambient conditions and over a wide range of dispensing intervals. There is further a need for such a substrate dispenser to be compact, economical, and serviceable.

Further limitations and disadvantages of conventional and traditional substrate dispensing approaches will become apparent to one of skill in the art, through comparison of such systems with certain aspects of the present disclosure, as set forth in the remainder of the present application with reference to the drawings.

### SUMMARY

Disclosed are dispensers and methods for dispensing and degassing a liquid. The dispensers and methods may include a heater and a first tube constructed of a first material. The first tube may include a first end operable to be connected to a source of the liquid and a second end. The first tube may be connected to the heater via a conductive pathway thermally connecting the heater to the first tube. The first material may have a permeability such that a portion of the gas dissolved in the liquid passes through the first material to an atmosphere upon being degassed from a portion of the liquid within the first tube.

### BRIEF DESCRIPTION OF THE FIGURES

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1 shows an example dispensing system consistent with at least one embodiment of this disclosure.

FIG. 2 shows an example dispensing system consistent with at least one embodiment of this disclosure.

FIGS. 3A, 3B, 3C, 3D, and 3E each shows a different view of a dispenser consistent with at least one embodiment of this disclosure.

FIG. 4 shows a heater block consistent with at least one embodiment of this disclosure.

FIGS. 5A and 5B show a tube assembly consistent with at least one embodiment of this disclosure.

FIGS. 6A, 6B, and 6C show a heater assembly consistent with at least one embodiment of this disclosure.

FIG. 7 shows a schematic of a humidity layer consistent with at least one embodiment of this disclosure.

FIG. 8 shows a method consistent with at least one embodiment of this disclosure.

FIG. 9 shows a schematic of a controller consistent with at least one embodiment of this disclosure.

FIGS. 10A and 10B shows block diagrams of temperature controllers consistent with at least one embodiment of this disclosure.

FIGS. 11 and 12 show experimental data for a system consistent with at least one embodiment of this disclosure.

Corresponding reference characters indicate corresponding parts throughout the several views. The exemplifications set out herein illustrate exemplary embodiments of the disclosure, and such exemplifications are not to be construed as limiting the scope of the disclosure any manner.

### DETAILED DESCRIPTION

Disclosed herein are dispensing systems and methods for dispensing a fluid, sometimes referred to as a substrate. The systems and methods may include a dispenser that can control both temperature and dissolved gas concentration of the fluid when dispensed into a reaction vessel of an automated analytical instrument. For example, the systems and methods disclosed herein can control both the temperature of the fluid and the concentration of gasses, such as oxygen (dO₂), dissolved in the fluid.

As disclosed herein, a dispenser can heat the fluid to a controlled temperature and degas the fluid to a desired level over a wide range of ambient conditions and over a wide range of dispensing intervals. For example, the systems and methods disclosed herein can allow for a fluid to be dispensed at different ambient pressures that may be caused by changes in elevation above sea levels (e.g., Miami, FL vs. Chaska, MN) or weather conditions, such as low and high pressure systems that may be in an area.

Examples of dispensers disclosed herein may include a heater and a tube. The tube may be constructed of a material that is permeable to a gas dissolved in a fluid. The heater may heat a portion of the fluid in the tube. A portion of the gas dissolved in the fluid may degas and diffuse through the walls of the tube. The gas may then be vented to the surrounding atmosphere.

Examples of dispensers disclosed herein may include a first heater assembly and a second heater assembly. The first heat assembly may include a first heater, a first heater block, and a first tube assembly. The first heater block is in thermal communication with the first heater and may have an exterior surface that defines a groove. The groove may be helical and may be located about a longitudinal axis of the heater block.

The first tube assembly may have a first end connectable to a pump and a second end. The first tube assembly is located at least partially within the groove and encircles the first heater block. The first tube assembly includes an inner tube and an exterior tube. The inner tube is arranged coaxial inside the exterior tube to define an annular cavity. The annular cavity may allow degassed gases to be evacuated from the dispenser as disclosed herein. The inner tube is made of an air permeable material and the exterior tube may be made of a material that is permeable to air or components of air. For example, the exterior tube may be permeable to oxygen, but impermeable to water vapor and/or nitrogen.

The second heater assembly may include a second heater block and a second tube assembly. The second heater block is in thermal communication with the heater and has a surface that define a channel. As disclosed herein, the second heater block may be held at a constant temperature to stabilize and/or maintain the temperature of the liquid prior to dispensing. For example, the second heater block may maintain the temperature of the liquid in between dispenses. For instance, the time between dispenses may be as short as a few seconds to as long as multiple hours. Thus, the second heater block having a constant temperature may allow the liquid to remain at a constant temperature regardless of a time between dispenses.

The second tube assembly has a first end connected to a second end of the first tube assembly and a second end in fluid communication with a dispensing nozzle. The second tube assembly is located at least partially within the channel. A probe includes a third tube that connects the second end of the second tube assembly and the dispensing nozzle. The probe includes a thermally conductive material in thermal communication with the second heater block and encircles a portion of the third tube. For example, a portion of the third tube may extend beyond the thermally conductive material to prevent the liquid from contacting the material. For instance, the liquid may be reactive with the material and the third tube may extend beyond the material to prevent an adverse reaction between the material and the liquid.

A temperature sensor is in thermal communication with at least one of the first heater block and the second heater block. A controller is in electrical communication with the temperature sensor and the heater. The controller is operable to perform actions. The operations include continuously receiving a signal from the temperature sensor, regulating a temperature of the first heater block and the second heater block based on the signal, and periodically dispensing the liquid.

Consistent with examples disclosed herein, a dispenser may be configured to dispense a liquid, to control temperature of the dispensed liquid, and/or to control dissolved gas in the dispensed liquid. The dispenser may include an inlet, an outlet, a first heater, a first tube, and/or an encapsulating arrangement. The first tube may extend along a length from a first end to a second end. The first tube may be configured for permeation of dissolved gas through a wall of the first tube. The encapsulating arrangement may be configured to encapsulate the first tube over at least a portion of the length of the first tube. The encapsulating arrangement may include a membrane configured for permeation of gas and containment of the liquid.

As disclosed herein, the heater may be configured to supply heat to the first tube and the first tube may be configured to transfer at least a portion of the heat to the liquid within the first tube and thereby control the temperature of the dispensed liquid. The first tube and the membrane may be configured to release dissolved gases from the liquid and thereby control dissolved gas in the dispensed liquid. A second heater and/or a second tube may be included to further control the temperature of the liquid as disclosed herein.

The above discussion is intended to provide an overview of subject matter of the present patent application. It is not intended to provide an exclusive or exhaustive explanation of the invention. The description below is included to provide further information about the present patent application.

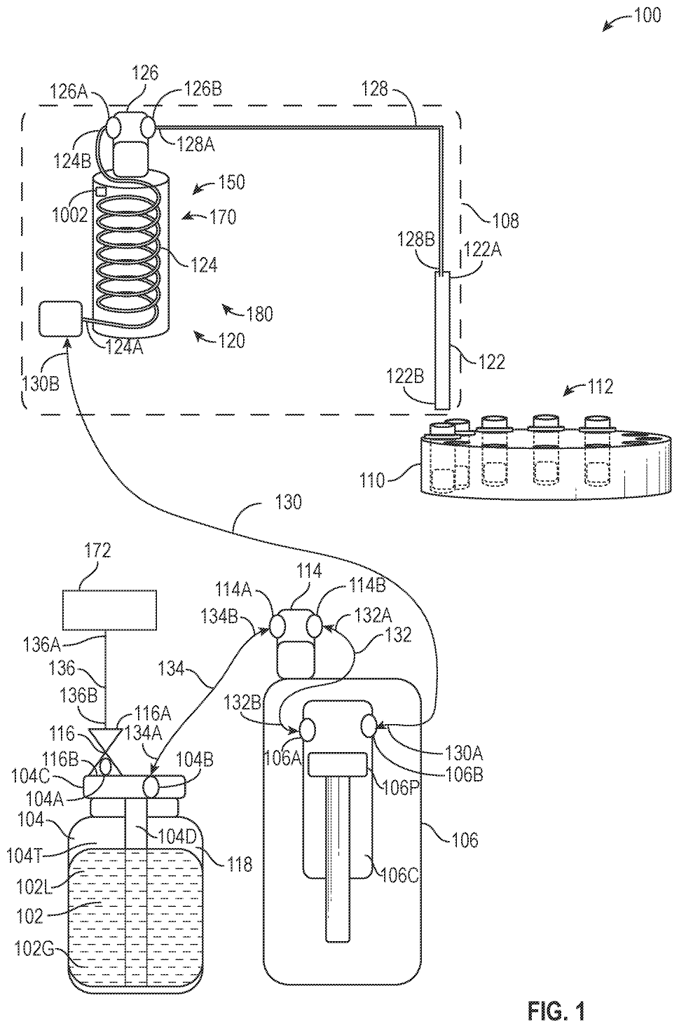

Turning now to the figures, FIG. 1 shows an example dispensing system 100 (i.e., a dispenser arrangement) consistent with at least one embodiment of this disclosure. System 100 may include a liquid 102 contained in a bottle 104, a pump 106, a dispenser 108 (i.e., a dispenser arrangement), and a wash wheel 110. Liquid 102 may include a liquid component 102L in which a gas component 102G may be dissolved. Bottle 104 may include a first port 104A, a second port 104B, a cap portion 104C, a dip tube 104D, and a tank portion 104T. As disclosed herein liquid 102 may be contained in tank portion 104T and during use, dispensed via cap portion 104C and dip tube 104D, which may be at least partially submerged in liquid 102.

Pump 106 may include a first port 106A, a second port 106B, a cylinder 106C, and piston 106P. During operation piston 106P may stroke within cylinder 106C. The stroking action may draw portions of liquid 102 into pump 106 via first port 106A and out of pump 106 via second portion 106B.

Wash wheel 110 may contain one or more sample vials 112. For example, wash wheel 110 may be configured to hold 9, 10, 27, 30, etc. vials 112. Liquid 102, sometimes referred to as a substrate, may be reagent or other solution used in an assay or other analytical procedure. Non-limiting examples of vials 112 may include reaction vessels of an immunoassay analyzer, cuvettes, etc.

During operation, pump 106, which may be a syringe pump, may extract portions of liquid 102 from bottle 104. During extraction of liquid 102 from bottle 104, a pump inlet valve 114, sometimes referred to as an inlet valve, may open and/or close fluid flow between first port 114A and second port 114B to allow liquid 102 to flow from bottle 104 to dispenser 108. In addition, pump inlet valve 114 may also open to allow liquid 102 to flow back to bottle 104 to account for changes in density of liquid 102 due to heating, cooling, thermal expansion, changes in ambient pressure, etc. For example, during period of inactivity, pump inlet valve 114 may be in an open position to allow liquid 102 to flow back into bottle 104. Pump inlet valve 114 may be connected to pump 106 via a tube 132. For example, a first end 132A of tube 132 may be connected to second port 114B of pump inlet valve 114 and a second end 132B of tube 132 may be connected to a first port 106A of pump 106.

As disclosed herein, the pressure and temperature differentials of fluid 102 inside of tubing dispensing system 100 are driving factors in how much degassing takes place in the dispenser. Ideally, the pressure differential between fluid 102 and ambient atmospheric pressure would be constant. The actual gauge pressure differential measured from inside system 100 to outside dispensing system 100 (i.e., ambient conditions) can be measured and is different from zero. The amount of gas dissolved in a liquid is proportional to the concentration of that gas and the pressure that it is under (amongst other factors). Experiments have revealed that heating up a fluid, such as liquid 102, in a degasser allows for expansion of the fluid contributing to a pressure build up between pump inlet valve 114, pump 106, a degasser loop (i.e., tube 124), and dispense valve 126. This pressure build up impacts the ability of the heater to degas liquid 102 which then impacts the relative light unit (RLU) produced by liquid 102.

As disclosed herein, degassing of oxygen due to temperature/pressure changes can be described as an equilibrium process. For example, Henry's law states that: At a constant temperature, the amount of a given gas dissolved in a given type and volume of liquid is directly proportional to the partial pressure of that gas in equilibrium with that liquid.

For a given temperature, which is set by heater assembly 120, which may include coils 150, a tube arrangement 170, and a heater arrangement 180, at about 37° C., and a partial pressure set by ambient conditions, oxygen diffuses through a membrane material (i.e., the material that makes up tube 124) to the external atmosphere. A relationship that governs permeation is based on Fick's law of diffusion and Henry's law of solubilities as disclosed herein.

A check valve 116 may include a first port 116A and a second port 116B. Check valve 116 may allow ambient air to flow into bottle 104 via first port 116A as liquid 102 is removed thereby preventing a vacuum and/or negative internal pressure from forming within the bottle 104. As liquid 102 is removed from bottle 104, a gas, such as ambient air or other gases as disclosed herein, that flows into bottle 104 via check valve 116 adds to a headspace 118 inside tank portion 104T of bottle 104. As disclosed herein, portions of liquid 102 that are in pump 106 may flow back into bottle 104 via valve 114 and a tube 134 having a first end 134A connected to dip tube 104D and a second end 134B connected to first port 114A of valve 114. Since liquid 102 is substantially incompressible, any gasses in headspace 118 may be compressed. The increased pressure within bottle 104 may drive gasses in headspace 118 into liquid 102 forming a solution of the gasses. These gasses may be removed during dispensing operations as disclosed herein. Headspace 118 may be included in the bottle 104 when the liquid 102 is packaged in the bottle 104 (e.g., at a filing factory).

To limit dissolvable gasses that may enter bottle 104, bottle 104 may be connected to a tank 172 or other supply of a gas that is not dissolvable in liquid 102 and/or does not affect an assay procedure. For example, a tube 136 may have a first end 136A that is connected to tank 172 and a second end 136B that is connected to check valve 116. The assay procedure may not be affected by argon dissolved in liquid 102. Thus, instead of allowing ambient air to enter bottle 104 via check valve 116, check valve 116 may be connected to an argon supply or any other inert gas.

From pump 106, liquid 102 may flow into dispenser 108. Dispenser 108 may dispense metered amounts of liquid 102 having a specified dissolved gas concentration and at a specified temperature into vials 112 as disclosed herein.

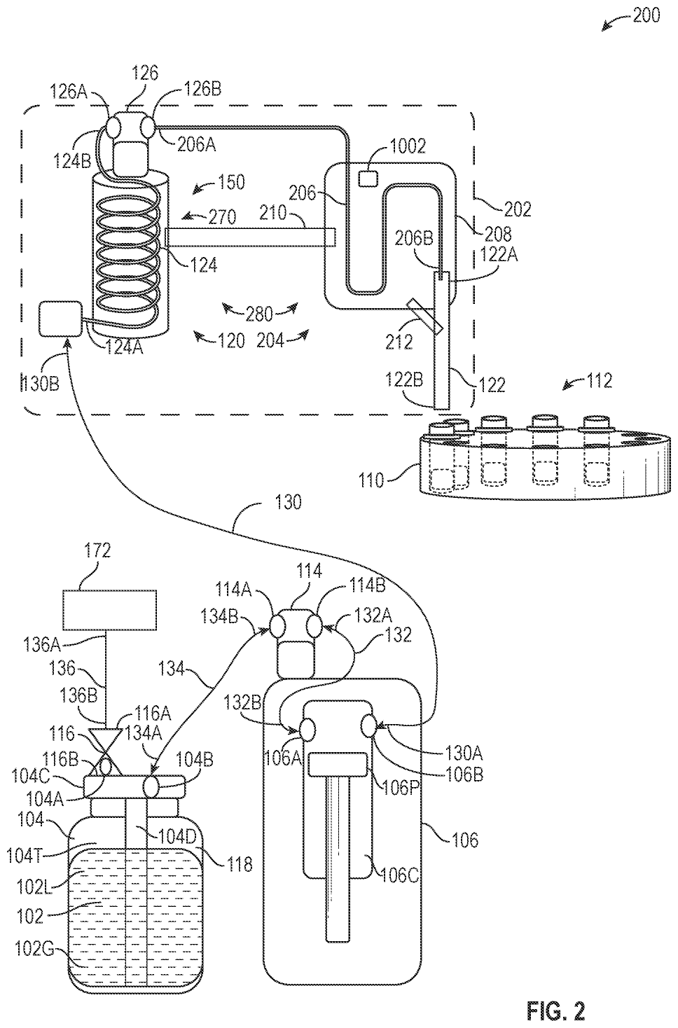

Dispenser 108 can include a heater assembly 120 and a probe 122. Probe 122 may include a first end 122A, which may be connected to a second end 128B of a tube 128, and a second end 122B, which may allow portions of liquid 102 to be dispensed into vials 112. A first end 128A of tube 128 may be connected to a second port 126B of a dispensing valve 126. While FIGS. 1 and 2 show tube 128 terminating at first end 122A of probe 122, tube 128 may continue through probe 122 in a continuous manner or probe 122 may include a separate tube as disclosed herein. During operation, liquid 102 may flow from pump 108 into heater assembly 120. As disclosed herein, liquid 102 may be heated from a first temperature to a second temperature while traveling through and/or while stationary within a tube 124 of heater assembly 120. Tube 124 may include a first end 124A, which may be connected to a second end 130B of a tube 130, and a second end 124B, which may be connect to a first port 126A of dispensing valve 126. Tube 130 may include a first end 130A that may be connected to second port 106B of pump 106. For example, liquid 102 may be stored at a temperature of about 4° C. and during use in the vial 112 needs to be at about 37° C. While traveling through heater assembly 120, liquid 102 may be heated from about 4° C. to about 37° C. During times when liquid 102 is not being dispensed, heater assembly 120 may heat liquid 102 to maintain liquid 102 at a temperature of about 37° C. and ready for on-demand usage.

As disclosed herein, while liquid 102 is in tube 124, liquid 102 may be degassed. Liquid 102 may have absorbed gases, such as ambient air, or constituents of ambient air, during storage or via the pumping process, such as air that may have entered bottle 104 via check valve 116. For using in an assay procedure, the concentration of gases dissolved in liquid 102 may need to be within a specified concentration. As liquid 102 travels through heater assembly 120, liquid 102 may be degassed as disclosed herein to achieve the desired concentration. Thus, as disclosed herein, dispenser 108 may both heat and control dissolved gas levels (e.g., dissolved oxygen (dO₂)) in liquid 102 as it is dispensed.

As disclosed herein, and during operation, dispenser 108 may dispense liquid 102 into vials 112. Pump 106 may maintain a pressure within the system, and dispensing valve 126 may actuate to allow liquid 102 to flow through dispenser 108. During operations, an instrument, such as an immunoassay analyzer, may operate at up to 450 tests per hour (TPH), and dispenser 107 may deliver an amount, such as up to 200 μL, of liquid 102 every 8 seconds into individual vials 112 of the instrument. This flow rate thus results in a periodic flow of up to 1,500 μL/minute or 1.5 mL/minute. If a lull in testing should occur on the instrument, dispenser 108 may pause dispensing (e.g., for seconds, for minutes, for hours, etc.) and dispenser 108 can maintain the performance characteristics mentioned herein at least with respect to temperature and dissolved gas concentrations for liquid 102. For example, dispenser 108 may repeatedly dispense 200 μL of liquid 102 at a temperature of about 37.0° C.±0.7° C. under specified laboratory conditions. The specified laboratory conditions may be 18° C. to 32° C. and atmospheric pressure for operation of immunoassay analyzers.

Dispenser 108 may dispense liquid 102, which may be substrates with aqueous substrate formulations (e.g., an aqueous solution, an aqueous buffer solution, etc.). The substrates may be nearly 99.8% water, such as by molarity concentration. Thus, in embodiments disclosed herein, water may be used as a first approximation of the substrate's properties.

Dispensers disclosed herein (e.g., dispenser 108) may dispense substrates with improved performance characteristics. For example, U.S. Pat. No. 10,703,971 B2, entitled “Chemiluminescent Substrates,” discloses alkaline phosphatase chemiluminescent substrate formulations with rapid incubation periods and improved stability for use in immunoassays. The contents of U.S. Pat. No. 10,703,971 B2 are hereby incorporated by reference herein in their entirety. The dispensers disclosed herein may include features that are disclosed in U.S. Pat. No. 10,562,021 B2, entitled “Dispenser for an Analyzer,” such as balanced heat transfer and thermal management techniques. The contents of U.S. Pat. No. 10,562,021 B2 are hereby incorporated by reference herein in their entirety.

FIG. 2 shows an example dispensing system 200 (i.e., a dispenser arrangement) consistent with at least one embodiment of this disclosure. Dispensing system 200 may include pump 106 and a dispenser 202 (i.e., a dispenser arrangement) that can dispense liquid 102 into vials 112 as disclosed above with respect to FIG. 1. Dispenser 202 may include a heater assembly 204. Heater assembly 204 may include a tube 206 and heater block 208.

After leaving first heater assembly 120, liquid 102 may flow into tube 206. As disclosed herein, tube 206 may be embedded, partially or completely, in heater block 208. Tube 206 may include a first end 206A that may be connected to second port 126B of valve 126 and a second end 206B that may be connected to first end 122A of probe 122. Tube 206 may be constructed of a material that is either permeable or impermeable to the gas dissolved in liquid 102.

As disclosed herein, heater block 208, which may include a tube arrangement 270 and a heater arrangement 280. may be held at a near constant temperature. For example, heater block 208 may be held as the desired temperature in which liquid 102 needs to be for use in the assay procedure (e.g., about 37° C.). As liquid 102 flows through second block 208, the temperature of liquid 102 say be stabilized at the second temperature. For instance, while traveling through first heater assembly 112, liquid 102 may be in a transient state where the temperature rises from the first temperature to the second temperature. Traveling through second heater assembly 204 may allow liquid 102 to reach a steady state with regard to temperature change before being dispensed.

First heater assembly 120 and second heater assembly 204 may be connected by a thermally conductive pathway 210. Probe 122 may be connected to second heater assembly 204 by a thermally conductive pathway 212. Thermally conductive pathways 210 and 212 may include thermally conductive materials, such as metals, that thermally bond components together. Thermally conductive pathways 210 and 212 may also be formed by having the components directly connected to one another. For example, first heater assembly 120 may be directly connected to second heater assembly 204 to form thermally conductive pathway 210 and second heater assembly 204 may be directly connected to probe 122 to form thermally conductive pathway 212.

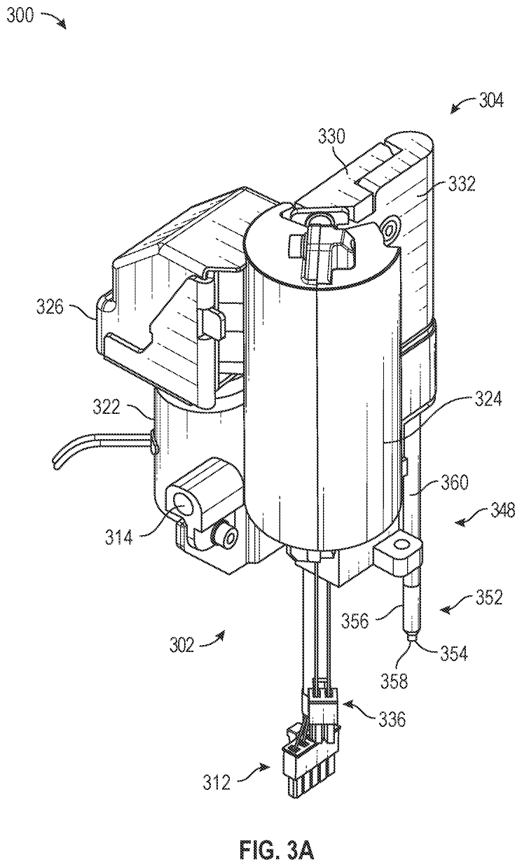

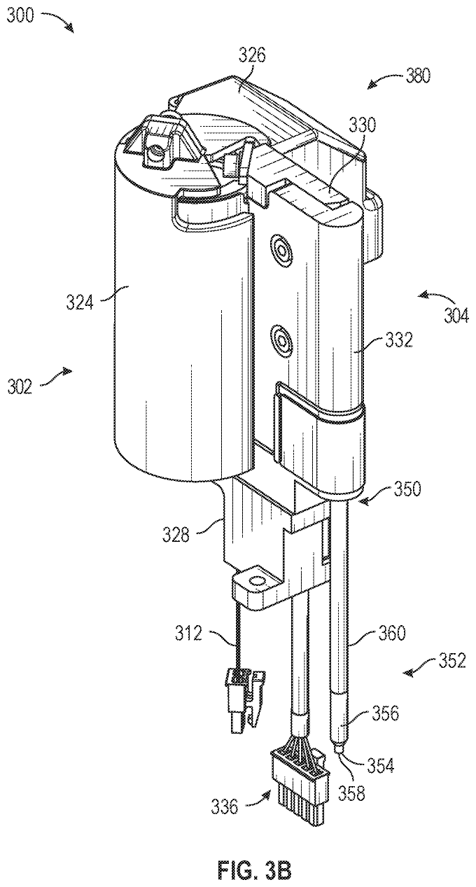

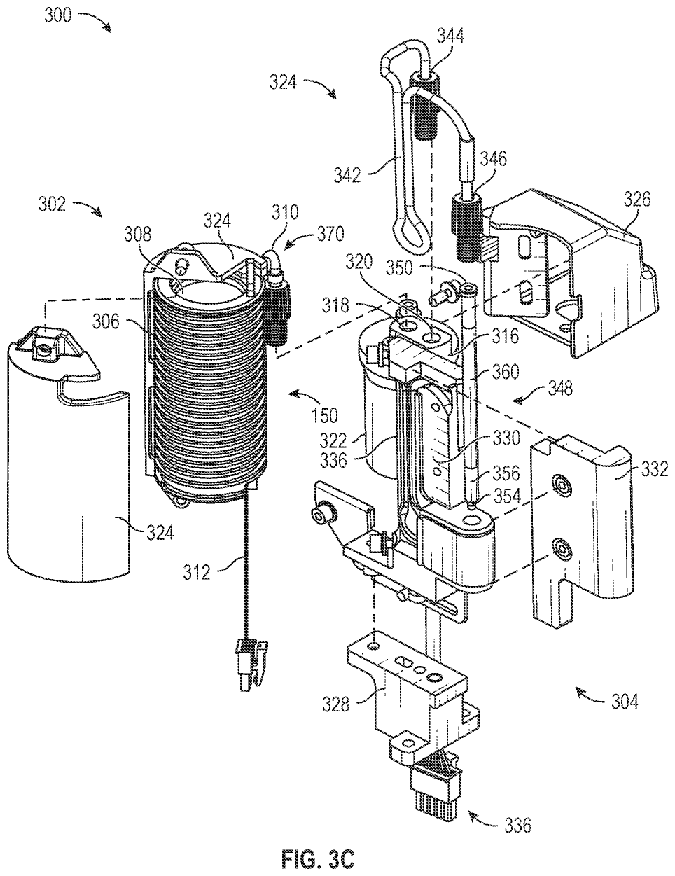

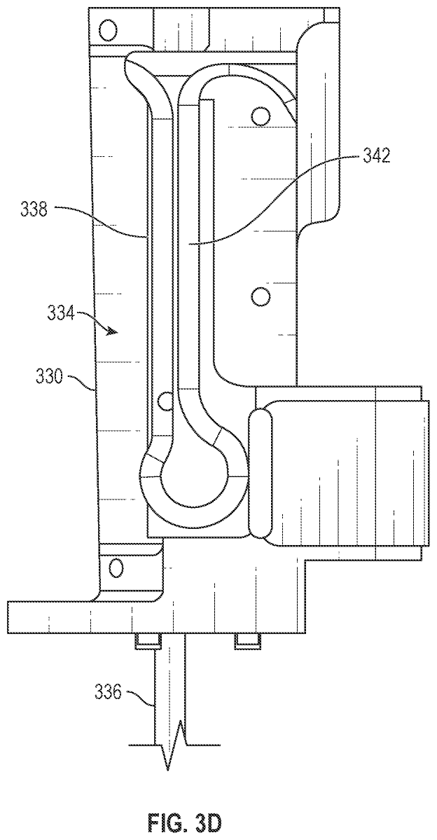

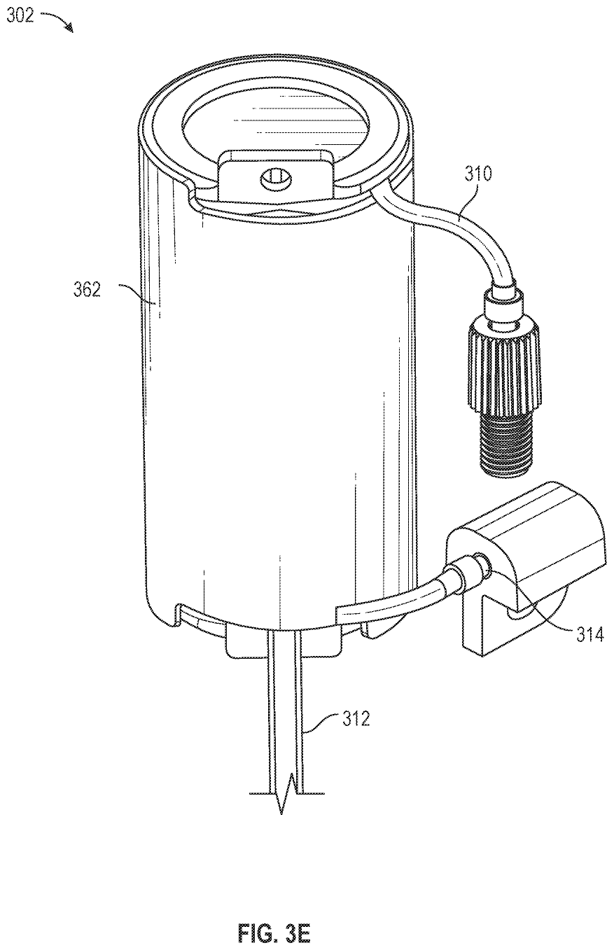

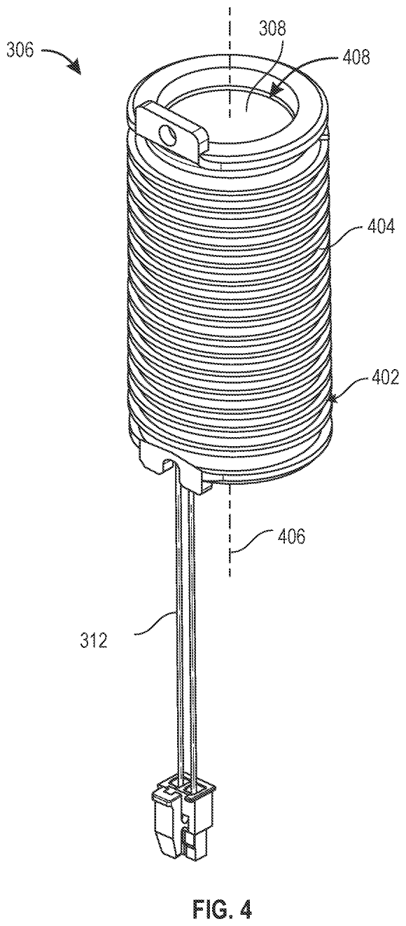

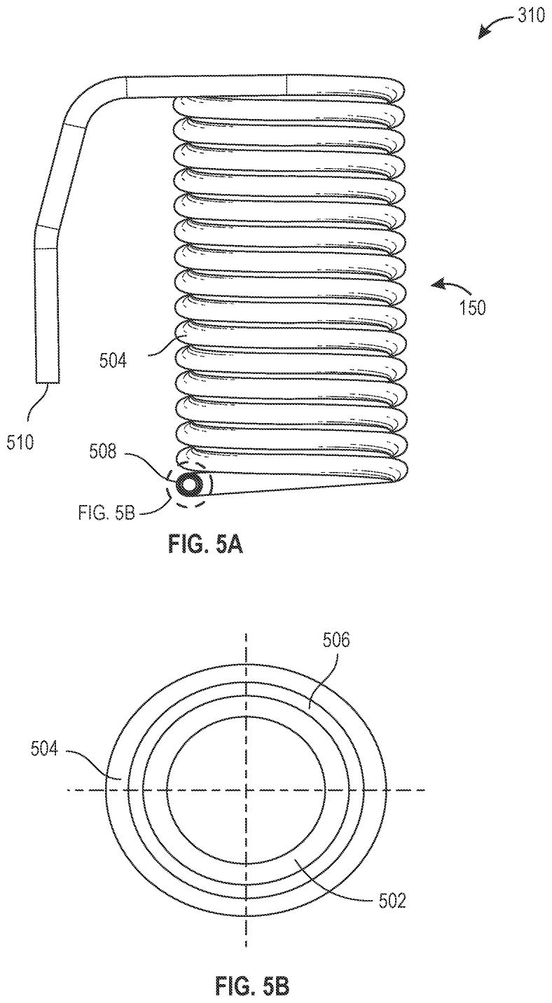

FIGS. 3A, 3B, 3C, 3D, and 3E each shows a different view of a dispenser 300 (i.e., a dispenser arrangement), such as dispenser 108 and 202, consistent with at least one embodiment of this disclosure. As disclosed herein dispenser 300 may include a first heater assembly 302, such as heater assembly 120, and/or a second heater assembly 304, such as heater assembly 204, sometimes referred to together or individually as heater arrangement 380. First heater assembly 302 may include a first heater block 306, a first heater 308, and a first tube assembly 310. In FIG. 3C, the portion of first tube assembly 310 that may encircle first heater block 306 have been omitted for clarity and are shown and described at least with respect to FIGS. 5A and 5B. FIG. 4 shows first heater block 306 in greater details consistent with at least one example of this disclosure. As shown in FIG. 4, first heater block 306 may include exterior surface 402 that defines a groove 404. Groove 404 may be a helical groove that traverses a length of first heater block 306 along a longitudinal axis 406 of first heater block 306. A helical pathway may allow for round tubing to be pressed into a pocket, rectangular or otherwise, with a full radius. This may allow for the most contact between an exterior surface of first tube assembly 310 and the surface groove 404 of first heater block 306, which may be an aluminum heat sink. While first heater block 306 is disclosed with groove 404, first heater block 206 may not have a groove or other surface features and first tube assembly 310 may be in direct contact with exterior surface 402. Use of a thermal epoxy or thermal grease may be used to reduce contact resistance between first tube assembly 310 and first heater block 306.

First heater 308 may be located within a cavity defined by an interior surface 408 of first heater block 306. Non-limiting examples of first heater 308 may include an electrical resistance heater formed by a flexible material that can line at least a portion of interior surface 408. One or more wires 312 can connect first heater 308 to a controller as disclosed herein.

As disclosed herein, first tube assembly 310 may be located at least partially within groove 404 and connected to a port 314 that allows liquid 102 to flow from pump 106 into dispenser 300. By locating first tube assembly 310 within groove 404, portions of first tube assembly 310 in contact with first heater block 306 can absorb heat transferred from first heater 308 into first heater block 306. The absorbed heat can then transfer to liquid 102 to both heat and degas liquid 102 as disclosed herein. Stated another way, first heater block 306 can form a conductive pathway for heat to flow from first heater 308 to first tube assembly 310 and into liquid 102 located within first tube assembly 310.

FIGS. 5A and 5B show first tube assembly 310 consistent with at least one embodiment of this disclosure. First tube assembly 310 may include a first tube 502 and a second tube 504. As disclosed herein, first tube 502, sometimes referred to as an inner tube, may be arranged coaxially inside second tube 504, sometimes referred to as an outer tube. As disclosed herein, first tube 502 and second tube 504 may form an annulus, or annular cavity 506. As a portion of liquid 102 is heated inside first tube 502 and dissolved gases are released, the degassed gasses can travel through first tube 502 and into annular cavity 506. Once inside annular cavity 506, the degassed gasses can travel at least in a direction along longitudinal axis 406 of first heater block 306 and be vented to the atmosphere.

The gasses removed from solution may also diffuse through second tube 504 and be vented to the atmosphere. As disclosed herein, the gasses removed from solution or components thereof, such as water vapor, may condense in annular cavity 506 and be evacuated as well.

First tube 502 may be made of a material that allows oxygen, water vapor, and other gasses, but not liquid 102 to permeate through it. In other words, first tube 502 may be permeable to gasses and/or an air permeable material, but not impermeable to liquids, such as liquid water and water vapor. For example, first tube 502 may be made of a silicone based material and/or a fluorinated ethylene propylene (FEP) material. For example, silicone rubber has a permeability for oxygen ranging from about 3940 (cm³*mm)/(m²*d*atm) and can allow for oxygen that is degassed from liquid 102 located within first tube 502 to pass into annular cavity 506 formed by first tube 502 and second tube 504.

Second tube 504 may be an air impermeable material to contain the degassed oxygen and other gasses within a defined space such as annular cavity 506. Second tube 504 may also be made of an air permeable material to allow the degassed oxygen and other gasses within annular cavity 506 to vent to the atmosphere. Non-limiting examples of materials second tube 504 may be made of include silicone based materials, perfluoroalkoxy alkane (PFA) materials, polytetrafluorethylene (PTFE) materials, fluoropolymer materials, and tetrafluoroethylene materials. The first tube 502 may include a relatively thick wall that is resistant to buckling, etc. The second tube 504 may include relatively thin walls that may buckle and/or otherwise undesirably deform. The first tube 502 may stabilize the second tube 504 from unwanted buckling and/or other deformation.

First tube assembly 310 includes a first end 508 and a second end 510. As shown in FIG. 3C, a manifold 316 may define a first port 318 and a second port 320. Manifold 316 may be a portion of a dispensing valve 322, such as dispensing valve 126. Dispensing valve 322 may be in electrical communication with a controller as disclosed herein to control dispensing of liquid 102.

Second end 510 of first tube assembly 310 can be fluidly connected to first port 318. Also as shown in FIGS. 3A, 3B, and 3C, a shroud 324 can encase first heater block 306, and first tube assembly 310. As second end 510 of first tube assembly 310 exits shroud 324, a housing 326 can cover portions of first tube assembly 310 to provide protection from damage. As second end 510 of first tube assembly 310 exits shroud 324, second tube 504 can exit first tube 502 to form an opening to allow degassed gasses to escape to the atmosphere. Shroud 324 may be constructed from a polymer such as acrylonitrile butadiene styrene (ABS).

The amount of dissolved gasses, such as oxygen and/or water vapor, transferred across a thin membrane, such as first tube 502, can be modeled mathematically. Equation 1 shows an example equation showing the volume of gas that permeates through a film with respect to time.

$$V ( t ) = \frac{ρ A Δ Pt}{β} \qquad Equation 1$$

where ρ is the gas permeability constant of the material, A is the surface area of the material, ΔP is the pressure differential of the applied system pressure relative to atmospheric pressure, t is time, and β is the thickness of the material. Gas permeability constants are defined under the units of Barrer and an example rate for oxygen is 4.50 Barrer.

As disclosed herein, permeant diffusion through the polymer film from the upstream atmosphere may include adsorption of the permeant by the polymer film at the interface with the upstream atmosphere. Diffusion of the permeant through the polymer film (i.e., through first tube 502) may be slow and may become a rate-determining step in gas permeation. Desorption of the permeant at the interface of the downstream side of the film may involve diffusion of the permeant away from the polymer film into the downstream atmosphere.

Gas permeability rate can be simplified to Equation 1 above that allows for the internal pressure control. Stated another way, JP in Equation 1 is the value in which control is sought. Experimentally, it has been discovered that this value can range from 0.5 psi up to 8.5 psi if pressure within dispensing systems, such as systems 100 and 200, is not vent back to a bottle with the liquid to be dispensed, such as bottle 104. Thus, the systems disclosed herein, are designed to vent any pressure that builds up within the fluidic system back to the bottle containing the primary fluid source (i.e., bottle 104). Specifically, this is accomplished by opening pump inlet valve 114 and closing dispense valve 126 so that fluids can only flow back to bottle 104.

As disclosed herein, a controller can open pump inlet valve 114 and close dispense valve 126 for periods of inactivity. Periods of inactivity may be defined as idle durations between dispenses not shorter than a preset time, such as 7 seconds, but not longer than a preset time, such as not longer than 24 minutes, during which any pressure buildup due to the heating of liquid 102 and expansion of dissolved gasses is allowed to move from first tube assembly 310 back through pump 106, pump inlet valve 114, and into bottle 104.

Using Equation 1, the approximate the amount of volume of dissolved oxygen pushed through second tube 504 over a typical timeframe can be found to about 5.4 mL. This assumes a surface area 0.01 m², a ΔP of 2 psi, and times ranging from 216 s to 864 s. Also, based on Equation 1, the rate of degassing can be controlled by adjusting a wall thickness for second tube 504.

To understand how capable dispensing systems, such systems 100, 200, and 300, are at pushing dissolved oxygen through second tube 504 it is important to first understand what may be needed. An elevation map can be used to calculate the amount of dissolved oxygen based on temperature and pressure in water. As examples, in Chaska, Minnesota (where liquid 102 may be manufactured and bottled) the amount of dissolved oxygen in water is about 1.58 mg/L. In Mexico City, a location with an elevation much higher than Chaska, Minnesota, the amount of dissolved oxygen in water is about 7.8 mg/L. These values are based on a normal pressure experience in Chaska, Minnesota and Mexico City and a temperature of the water of 4° C. Comparing the capability of a PFA tubing system to the required amount of dissolved oxygen needed to reach equilibration from a 4° C. substrate bottle use in Chaska is 11.94% and in Mexico City is 9.52% for a pipettor throughput of 4, or 450 tests per hour.

It is evident that when running at 4 pipettors, or 450 tests per hour, that only 9.5% to 12% of the dissolved oxygen is being taken out of solution. Using Equation 1, it can be determined how much oxygen can be taken out when a time, such as 20 minutes, has elapsed. In this example, the 20-minute time period has been empirically measured to be long enough to reduce the signal in an immunoassay analyzer down to the initial condition. Equation 1 shows that 66% of the dissolved oxygen can be transmitted through second tube 504 wall after 20 minutes. It should be noted that after 20 minutes, or even several hours, the initial results do not drop any further. The calculated percentage is only 66% of the equilibrated amount. Some of the extra amount of dissolved oxygen is believed to stay in the tubing as bubbles.

Second heater assembly 304 may be mounted to a mounting block 328 and can include a second heater block 330, a second heater 332, and a second tube assembly 334. As shown in FIG. 3C, second heater block 330 may include surface 336 that defines a channel 338. Channel 338 can traverse a length of second heater block 330. Non-limiting examples of second heater 332 may include an electrical resistance heater as described with respect to first heater 308. One or more wires 340 can connect second heater 332 and/or dispensing valve 322 to a controller as disclosed herein. First tube assembly 310 and/or second tube assembly 334 may sometimes be referred to as tube arrangement 370.

As disclosed herein, second tube assembly 334 can include a tube 342 that has a first end 344 connected to first port 318 and a second end 346 connected to a probe 348, such as probe 122. Tube 342 may be located at least partially within channel 338. By locating tube 342 within channel 338, portions of tube 342 in contact with second heater block 330 can absorb heat transferred from second heater 332 into tube 342. The absorbed heat can then transfer to portions of liquid 102 located within tube 342 to both to maintain liquid 102 at a desired temperature and oxygen concentration as disclosed herein. Use of a thermal epoxy or thermal grease may be used to reduce contact resistance between tube 342 and second heater surface 336.

Tube 342 can be made of a material that is imperable to the gasses dissolved in liquid 102. As a result, while located in tube 342, liquid 102 may not be degassed and/or any gasses dissolved in liquid 102 that degass may form bulbs within liquid 102.

Probe 348 can have an inlet 350 and a second end 352. Consistent with at least one example disclosed herein, probe 348 may have a tube 352 that is encircled by a thermally conductive material 356. A dispensing nozzle 358 may be connect to second end 352 of probe 348. Thermally conductive material 356 may be in thermal communication with second heater assembly 304, such as by direct connection to second heater block 330, such that heat can be conducted through thermally conductive material 356 to keep liquid 102 located within probe 348 at the desired temperature. A non-limiting example of thermally conductive material 356 is copper. Probe 348 may also include a thermal insulator 360 that encircles a portion or all of conductive material 356 to minimize heat loss from probe 348 to the atmosphere.

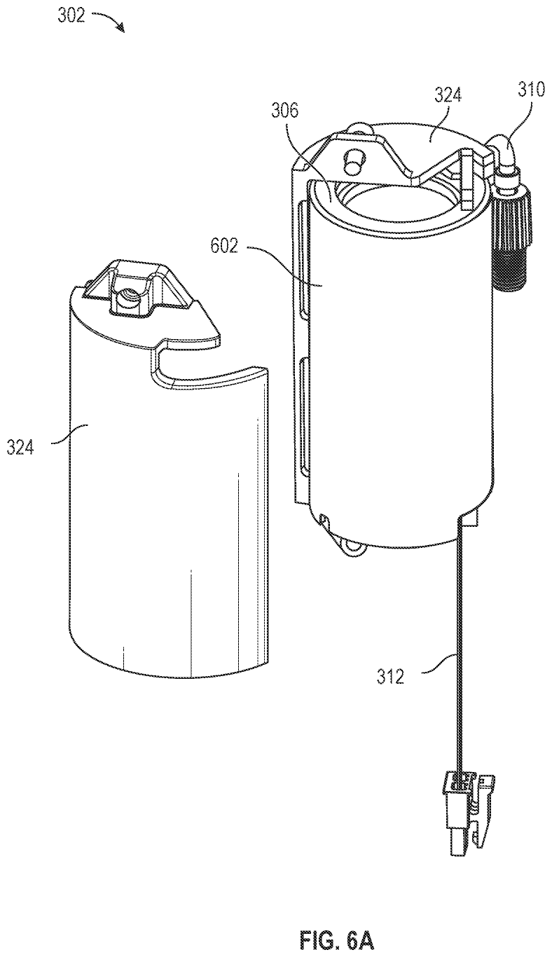

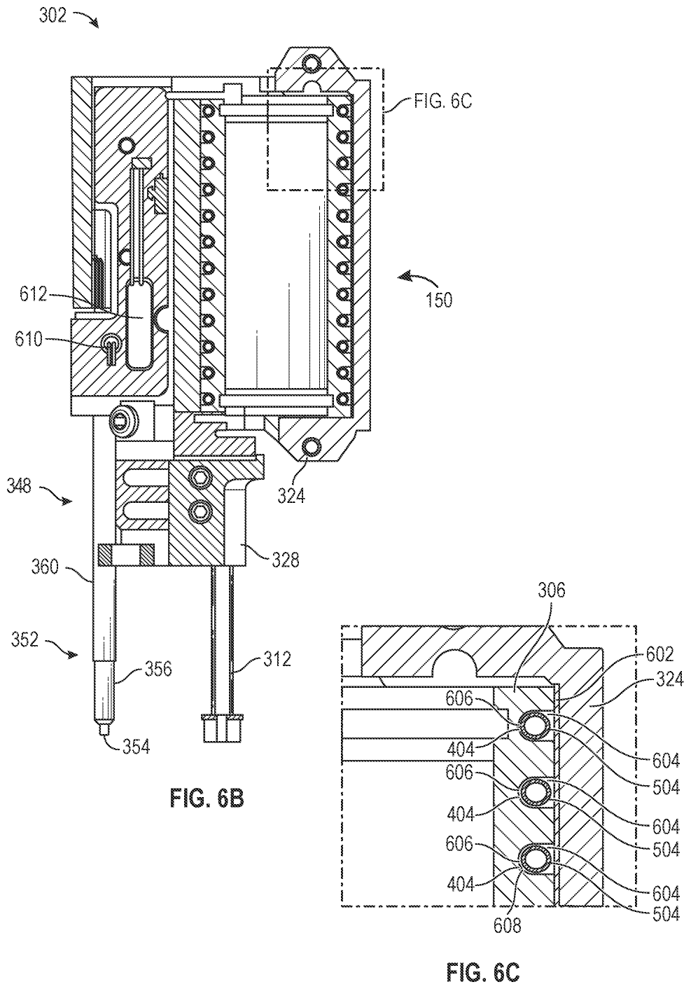

FIGS. 6A, 6B, and 6C show first heater assembly 302 consistent with at least one example of this disclosure. As shown in FIG. 6A, second tube 504 may encircle first heater block 306 and contact first heater block 306 at at least a portion 606 of groove 404 and first heater block 306 can be encircled with a membrane 602, sometimes called a sleeve. While FIGS. 6B and 6C show second tube 504 located in groove 404, second tube 504 may simply be in contact (as indicated by reference numeral 608) with first heater block 306 and/or first heater 308 without being located in a groove or other recessed feature, such as groove 404. Consistent with embodiments disclosed herein, the contact between second tube 504 and first heater block 306, first heater 308, or any other items may be a dry contact, a moisture contact (i.e., water or other thermal paste) and/or a bonded contact, such as by a solid bonding agent that may increase conduction heat transfer. Membrane 602 can be used when first tube assembly 310 includes first tube 502 and second tube 504 as shown by membrane 362 in FIG. 3E. Membrane 602 can also be used in place of second tube 504. In other words, instead of having first tube 502 located inside second tube 504 and forming annular cavity 506, first tube 502 can be located in groove 404 and membrane 602, in conjunction with exterior surface 402, can form a space 604 in which oxygen can travel to be evacuated to the atmosphere.

Membrane 602 may be made of a material that is permeable to air to allow degassed gasses to vent to the atmosphere. Membrane 602 may be made of a material that is impermeable to air to contain the degassed gasses within space 604 formed by membrane 602 and groove 404. Non-limiting examples of materials in which membrane 602 can be made of include perfluoroalkoxy alkane (PFA) materials, polytetrafluorethylene (PTFE) materials, fluoropolymer materials, and tetrafluoroethylene materials.

As shown in FIG. 6B, first heater assembly 302 may include a temperature probe 610 and a thermostat 612. As disclosed herein, temperature probe 610 may be used as part of a feedback or feedforward loop to control a temperature of first heater assembly 302 and/or portions of liquid 102 that are located in first tube assembly 310 and/or second tube assembly 334. Thermostat 612 may act as a safety device that servers power to a heater, such as first heater 308 or second heater 332, should the temperature of first heater assembly 302 exceed a preset threshold. For example, if the temperature of first heater assembly exceeds 40° C., then thermostat 312 may terminal current flow to first heater 308 and/or second heater 332.

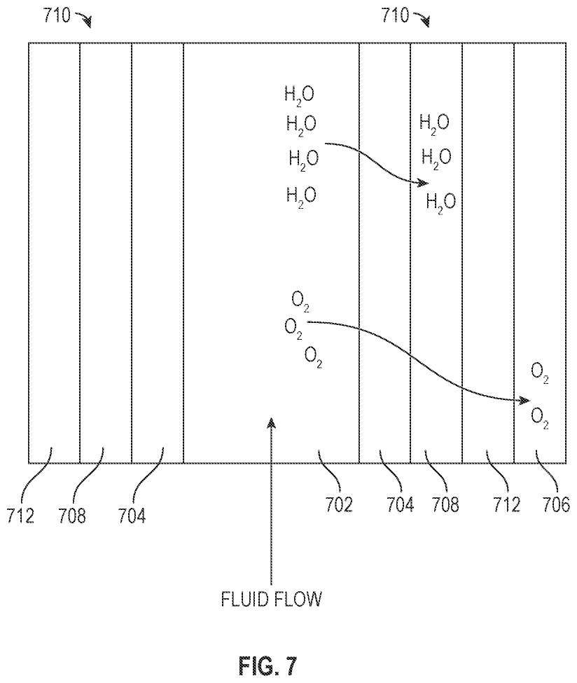

FIG. 7 shows a schematic of degassing consistent with at least one embodiment of this disclosure. As disclosed herein, pressure differentials between a fluid 702 and dissolved gasses inside tubing 704, which may be a silicone tubing, when compared to the ambient 706 may drive degassing as disclosed herein and describe by Equation 1.

As disclosed herein, as a gas, such as oxygen degasses from fluid 702, the gas may diffuse through tubing 704. Because fluid 702, which in this example is water, may also vaporize and diffuse through tubing 704. The water vapor may condense to form a condensation layer 708 (e.g., liquid water) in an annular cavity 710 formed by tubing 704 and tubing 712. While referred to as “tubing 712,” element 712 may be a membrane or sleeve as disclosed herein. Tubing 712 may be a FEP material as disclosed herein.

As disclosed herein, FIG. 7 may be a representation of degassing that may happen in first tube assembly 310. For example, tubing 704 may be first tube 502 and tubing 712 may be second tube 504. Condensation layer 708 may form in annular cavity 506 as water vapor and degassed gassed defuse through tube 704. Tubing 712 may be impermeable to water and thus contain condensation layer 708, which can be drained and disposed of. Oxygen and other gasses may diffuse through tubing 712 and vented to the atmosphere.

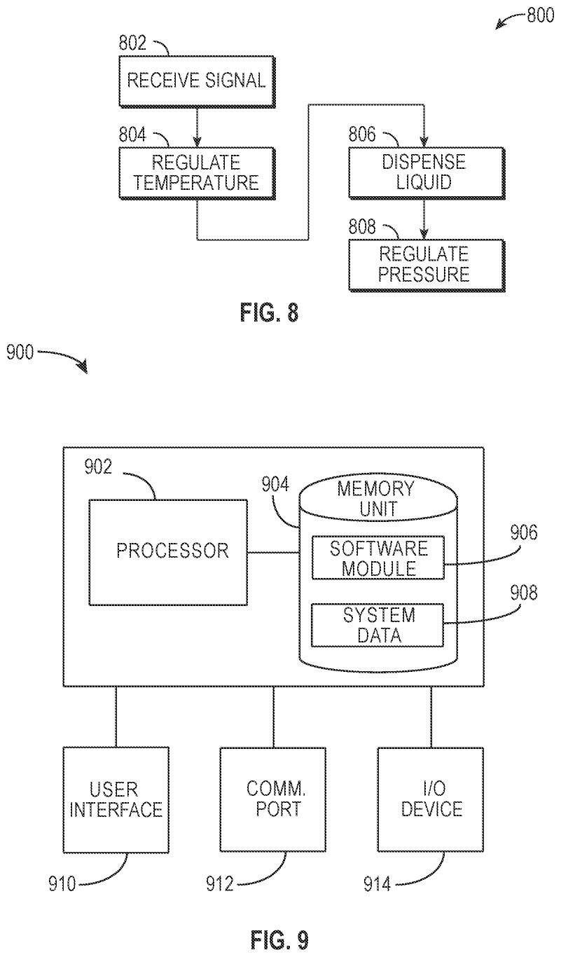

FIG. 8 shows a method 800 for controlling a dispenser consistent with at least one embodiment of this disclosure. Method 800 may begin at stage 802 where one or more signals may be received by a controller, such as controller 900 described below with respect to FIG. 9. The signals may be received from one or more temperature probes connected to first heater assembly 302 and/or second heater assembly 304. For example, the signals may be continuously received and may be a voltage that is generated by a one or more thermistors and/or thermocouples in contact with first heater assembly 302 and/or second heater assembly 304. Controller 900 may convert the signals to a temperature.

Using the signals, controller 900 may regulate the temperature of first heater block 306 and/or second heater block 330 based on the signal (804). For example, using the signals to determine a temperature of first heater block 306 and/or second heater block 330, controller 900 may increase or decrease a voltage and/or current being supplied to at least one of first heater 308 and/or second heater 332 to increase or decrease the temperature of first heater block 306 and/or second heater block 330. While regulating the temperature of first heater block 306 and/or second heater block 330, controller 900 may also periodically dispense liquid 102 (806).

As disclosed herein, method 800 may also include actuating valves (808). For example, during periods of inactivity, controller 900 may actuate pump inlet valve 114 and dispense valve 126 to vent off gasses back to bottle 104. For instance, a first pressure probe may transmit signals to controller 900 to measure a system pressure within a dispenser. A second pressure probe may transmit signals to controller 900 to measure ambient pressure. Controller 900 may determine a pressure differential between the system pressure and the ambient pressure. During periods of inactivity and when the pressure differential exceeds a preset value, controller 900 may simultaneously open pump inlet valve 114 and close dispense valve 126.

FIG. 9 shows a schematic of controller 900 consistent with at least one embodiment of this disclosure. Controller 900 may include a processor 902 and a memory 904. Memory 904 may include a software module 906 and system data 908. While executing on processor 902, software module 902 may perform operations for controlling a dispensing system, such as systems 100 and 200, including, for example, one or more stages included in method 700. Controller 900 also may include a user interface 910, a communications port 912, and an input/output (I/O) device 914.

As disclosed herein, software module 906 may include instructions that, when executed by processor 902, cause processor 902 to receive signals from temperature probes and increase and/or decrease voltages and/or currents supplied to heaters in response to determining a temperature using the received signals. Software module 906 also may include instructions that, when executed by processor 902, cause processor 902 to cause dispenser 106 to periodically dispense liquid 102. For example, to dispense liquid 102 controller 900 may transmit one or more signals to pump 106 and/or dispensing valve 126. The one or more signals may actual pump 106 and/or dispensing valve 126 to dispense liquid 102.

System data 908 may include data related to properties of material used to manufacture the various tubes and/or tube assemblies disclosed herein. Other system data 908 may include properties of liquid 102, any gasses that may be dissolved in liquid 102, desired temperature and/or dissolved gas concentrations for dispensing liquid 102, formulas and/or lookup tables to convert voltages to temperatures, etc. For example, system data 908 may include formulas that allow controller 900 to receive a voltage from a temperature probe and convert the voltage to a temperature.

User interface 910 can include any number of devices that allow a user to interface with controller 900. Non-limiting examples of user interface 910 include a keypad, a display (touchscreen or otherwise), etc.

Communications port 912 may allow controller 900 to communicate with various information sources and devices, such as, but not limited to, remote computing devices such as servers or other remote computers, mobile devices such as a user's smart phone, peripheral devices, etc. Non-limiting examples of communications port 912 include Ethernet cards (wireless or wired); BLUETOOTH® transmitters, receivers, and transceivers; near-field communications modules; etc.

I/O device 914 may allow controller 900 to receive and output information. Non-limiting examples of I/O device 914 include, temperature probes, a camera (still or video), biometric scanners, etc.

Consistent with embodiments disclosed herein, dispensing systems, such as dispensing systems 100 and 200 may include a temperature controller, which can be implemented using controller 900, configured to heat liquids dispensed from heaters to a predetermined temperature. For example, the temperature controller may include feedback circuitry that generates a control signal for a first heater based on an error signal that is the difference between a setpoint temperature and a feedback signal.

The temperature of liquid dispensed, such as liquid 102, from the dispenser is affected by both the temperature of a heater and the ambient temperature near the dispensed liquid. In some cases, it is not possible to directly measure the temperature of the dispensed liquid. In these situations, the feedback signal may be developed based on the measured temperature of the heater. The setpoint temperature can be developed using the ambient temperature measured at or near the dispensed liquid. The error signal is the difference between the setpoint temperature and the measured temperature of the heater.

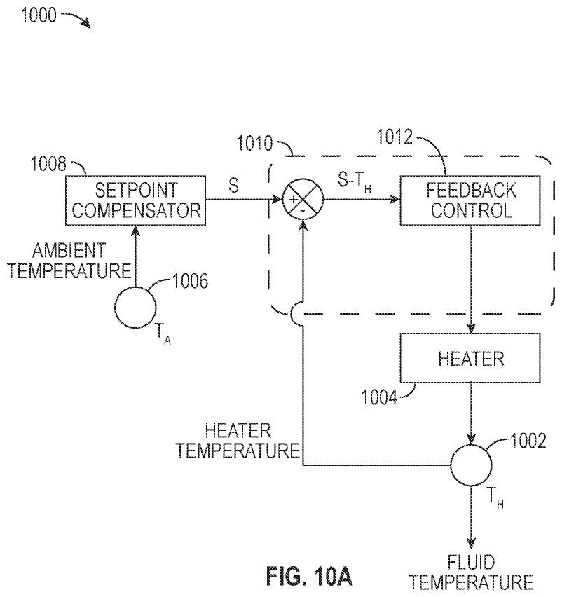

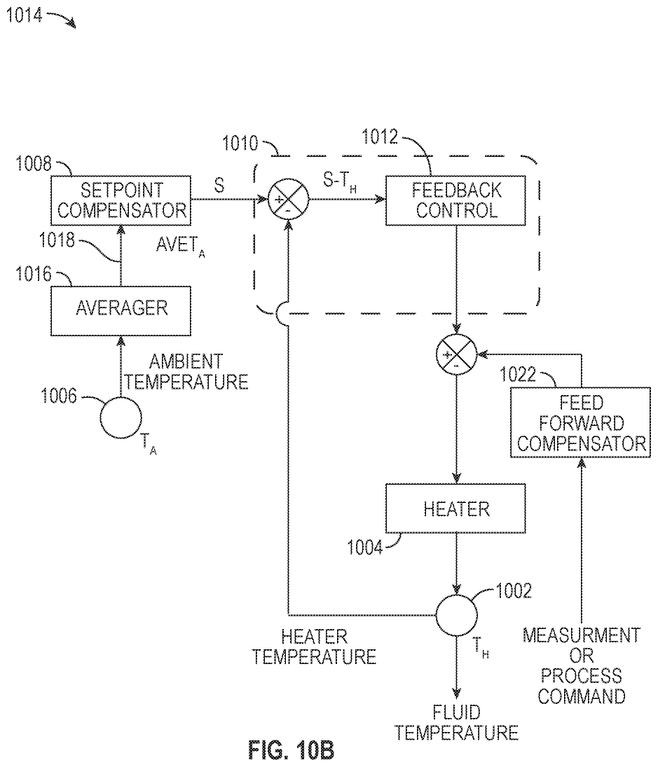

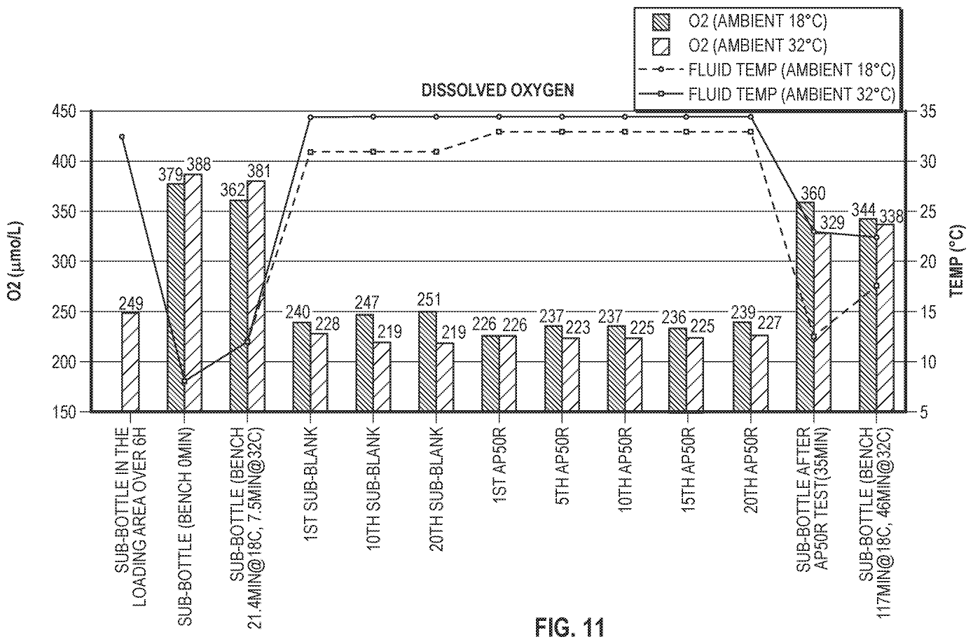

FIG. 10A shows a block diagram of a temperature controller 1000 that may be used in conjunction with a dispenser, such as dispensers 108, 202, and 300, in accordance with at least one embodiment of this disclosure. Temperature controller 1000 includes a first temperature sensor 1002 configured to measure temperature (Tₕ) of a heater 1004, such as first heater 308 or second heater 332. A second temperature sensor 1006 is configured to measure ambient temperature (Ta) near the dispensed liquid. For example, second temperature sensor 1006 may be located within a range of about 1 meter to about 0.1 cm from the dispensed liquid.

Temperature controller 1000 includes a setpoint compensator 1008 configured to determine a setpoint temperature (S) based on the ambient temperature (Tₐ). Feedback control circuitry 1010, which may include a feedback controller 1012, generates a control signal for heater 1004 based on a difference between the setpoint temperature (S) and the temperature (Tₕ) of heater 1004.

Suitable temperature sensors for first and/or second sensors 1002, 1006 can include thermistors, thermocouples, infrared sensors, optical sensors, resistance temperature devices (RTD), for example. Any type of feedback controller may be useful in the disclosed embodiments, including but not limited to thermostatic control, model-based control, and proportional control such as proportional integral derivative control (PID).

According to some aspects, setpoint compensator 1008 may develop the setpoint temperature based on a model, e.g., a model derived from empirical data. For example, setpoint compensator 1008 may calculate the setpoint temperature as a function of ambient temperature f(Tₐ), where f(Tₐ) is a polynomial having degree ≥2. Functions other than polynomial functions can alternatively be used as the model. In some implementations, the setpoint temperature, S, can be expressed as

S=ƒ(Tₐ)=kₙTₐⁿ+kₙ₋₁Tₐⁿ⁻¹+ . . . k₁Tₐ+k₀, Equation 2

where Tₐ is the measured ambient temperature, n is the degree of the polynomial, and kₙ, kₙ₋₁, . . . k₁, and k₀ are coefficients determined by a polynomial regression fit to empirical data. In Equation 2, coefficient k₀ represents the nominal setpoint temperature and the terms kₙTₐⁿ, kₙ₋₁Tₐⁿ⁻¹, . . . k₁Tₐ compensate the nominal setpoint temperature based on the empirical data.

According to some aspects, instead of using a function as described above, setpoint compensator 1008 may select setpoint temperature, S, based on values of Tₐ stored in a lookup table in memory.

FIG. 10B shows a temperature controller 1014 consistent with embodiments disclosed herein. In FIG. 10B, like reference numerals are used to indicate components previously shown in FIG. 10A and described above. In some implementations, it may be useful to smooth the ambient temperature measurements acquired by second temperature sensor 1006 using an averager 1016. Averager 1016 averages multiple ambient temperature measurements and produces a moving average Ta (AveTₐ) at its output wherein AveTₐ is the average of a fixed subset of measurements in a time series. For a time series of ambient temperature measurements, the first average is obtained by taking the average of the initial subset of the ambient temperature measurement series. After the first average is obtained, the subset is modified by moving forward in the measurement series—the first measurement of the series is discarded and the next measurement in the series is included in the subset. The average of the modified subset is obtained.

According to some aspects, the average AveTₐ may be a simple moving average, although the use of other averaging techniques is possible. Note that in embodiments that incorporate ambient temperature averaging, the value AveTₐ may replace Tₐ in Equation 2 above. Averaging the ambient temperature measurements slows the change in the setpoint temperature, S, produced by an outer circuit loop 1018 relative to the change in Tₕ produced by an inner circuit loop 1020. Slowing the speed of outer loop 1018 relative to inner loop 1020 may enhance stability of temperature controller 1014. Additionally, averager 1016 reduces noise and minor fluctuations in S. According to some embodiments, averager 1016 may average about 10 to about 1000 measurements of Tₐ. In some implementations, both Tₐ and Tₕ are measured about every 0.1 seconds and the averager 1016 averages about 100 samples of Tₐ to produce AveTₐ about every 10 seconds.

According to some embodiments, temperature controller 1014 may have a priori knowledge of a future event that causes a predictable change in heater demand. An example of such an event includes dispense cycles that push liquid through heater 1004. In response to the future event, temperature controller 1014 provides a measurement or process command to a feed forward compensator 1022. Feed forward compensator 1022 may apply an adjustment to the control signal of heater 1004 to compensate for the predictable change in heater demand.

### Specific Example

As a non-limiting specific example, the DxI 9000 Instrument System produced by Beckman Coulter of Brea, California can dispense 200 μL+/−10 μL, 200 μL+/−15 μL, or 200 μL+10 μL/−15 μL of substrate fluid within 37° C.+/−0.7° C. to a reaction vessel while the instrument experiences internal case temperature ranging from 18° C. to 36° C. In order to keep the Relative Light Unit (RLU) signal stable the substrate heater system, such as dispensers 108, 300, etc., may preheat a certain volume of substrate fluid for a certain period in order to degas dissolved oxygen from the process fluid. Degassing the dissolved oxygen may be needed since it has been experimentally determined that a slope of percent RLU vs percent dissolved oxygen is about 0.7 so a 10% change in dissolved oxygen may lead to 7% change in RLU. For the DxI 9000 application keeping RLU's within +/−6% of a standard substrate blank or functional RLU test is an important specification. Therefore, to be within +/−6% RLU the dissolved oxygen levels may need to be maintained within about +/−8.6% regardless of the throughput.

A customer can load a cold bottle from a refrigerator the immunoassay analyzer and run this bottle as soon as they would like. A cold bottle versus a room temperature bottle will have different levels of dissolved oxygen inside the process fluid. Not heating enough of the process fluid prior to the dispense can cause the RLU signal produces by a Lumi-AP diagnostic test to shift the results by anywhere from 10-20%. Heating the process fluid reduces the dissolved oxygen concentration thereby reducing the signal of the reaction vessel. It has been observed that the first dispense from the substrate heater is always lower than the following tests, especially when the instrument has sat idle for time periods longer than 15 minutes with the previous design. The previous design only held ˜700 μL of substrate or about 3 tests. Over long periods of time this heater was able to reduce the dissolved oxygen levels for the first 1 to 3 tests which lowered the signal from the substrate. However, when running many replicates every 8 seconds the subsequent replicates would shift up as high as 10%.

It has been experimentally observed, using the systems and methods disclosed herein, that this level can be reduced to as low as 2% when around 5,400 μL of fluid have been heated. A dispense consists of 200 μL per individual test, therefore the heater holds 27 tests worth of fluid inside of it. Since the instrument operates on an 8 second cycle each individual test is heated for a minimum of 216 seconds prior to being dispensed into an RV or test.

The instrument test throughput is defined as the amount of test per hour being produced by the instrument system. The DxI 9000 system operates at a level up to 450 tests per hour (TPH). This reduces down to delivering 1 dispense and/or completing 1 test every 8 seconds. Since the instrument operates with 4 pipettors producing one test every 32 seconds if an operator were to assign an assay to only 1 pipettor versus all 4 pipettors they could see results being populated every 32 seconds instead of every 8 seconds or 112.5 TPH versus 450 TPH. An instrument with a finite volume of process fluid within its fluid conduit will use the entire fluid conduit at different durations based on the instrument throughput. For the DxI 9000 immunoassay analyzer one dispense of the substrate process fluid is defined as 200 μL/test. The time that a single dispense sits inside the fluid conduit is 4 times longer at the lower 112.5 TPH throughput versus the 450 TPH throughput. The substrate process fluid known as Lumi-PHOS-Pro is dominantly composed of water The concentration of oxygen within water varies as a function of the partial pressure of oxygen in the gas phase in contact with water and the temperature of the water. It has been experimentally determined amount of light produced by Lumi-PHOS Pro (RLU) is proportional the concentration of dissolved oxygen in Lumi-PHOS Pro. More dissolved oxygen in substrate will produce higher RLU. Since the substrate is dominantly water, water can be used as a good proxy to understand the dissolved oxygen effects. Empirical measurements of dissolved oxygen and fluid temperature were measured in a previous experiment.

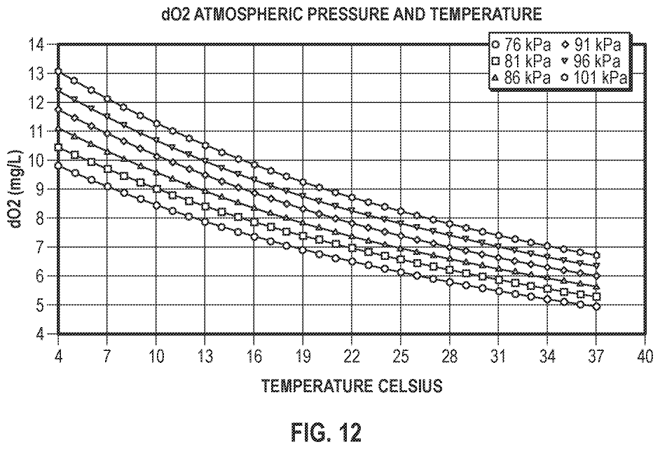

FIG. 11 shows dissolved oxygen in micro moles per liter. These values can be converted to milli-grams per liter by multiplying them by the molar weight of O₂ of 31.9988 grams/mole. FIG. 12 shows dissolved oxygen plotted at different temperatures and pressures ranging from Sea Level (0 meter, 101 kPa) and Mexico City (2,240 meters, 76 kPa) and from temperatures ranging from 4° C. to 37° C.

Beckman-Coulter, Chaska, Minnesota is nominally at an elevation of 285 m which corresponds to a standard pressure of 98 kPa. Lumi-PHOS Pro is stored in bulk at 2-8° C., filled into final consumables (bottles), and then immediately returned to 2-8° C. Bottles being delivered to customers in Mexico City at 76 kPa or used in Chaska, Minnesota at 98 kPa will be heated to 37° C. prior to dispensing into the RV. Once dispensed the substrate fluid will out gas the dissolved oxygen into the atmosphere in order to run down to the equilibration zone. It is important to note the relationship of temperature and pressure in the above graph. As temperature increases the amount of dissolved oxygen decreases. Also, as the elevation increases, which may result in a drop in ambient pressure, this also decrease the amount of dissolved oxygen solubility of water. As the fluid gets colder the amount of dissolved oxygen increases. Higher temperature and or higher pressure will reduce dissolved oxygen, which will decrease signal over time. As detailed herein, the amount of dissolved oxygen that needs to be removed from substrate from 4° C. to 37° C. based on bottling in Chaska and use in Chaska or Mexico City is 6.22 mg/L in Chaska and 7.8 mg/L in geographies as high as Mexico City. Using the systems and methods disclosed herein, the necessary dissolved oxygen can be removed.

### General Examples and Notes

The following, non-limiting examples, detail certain aspects of the present subject matter to solve the challenges and provide the benefits discussed herein, among others.

Example 1 is a dispenser arrangement configured to dispense a liquid with a gas dissolved in the liquid, the dispenser comprising: a tube arrangement including permeable material and extending between a first end and a second end; and a heater arrangement configured to transfer heat to the tube arrangement at one or more thermal contact areas; wherein the tube arrangement is configured to: transfer the liquid between the first and second ends of the tube arrangement, transfer at least some of the heat to the liquid, and degas the liquid by transferring at least some of the gas dissolved in the liquid through the permeable material.

In Example 2, the subject matter of Example 1 optionally includes wherein: the tube arrangement includes a tube, the permeable material includes a first permeable material and a second permeable material, the tube includes a first layer of the first permeable material, and the tube includes a second layer of the second permeable material.

In Example 3, the subject matter of Example 2 optionally includes wherein a condensation layer is positioned between the first layer and the second layer.

In Example 4, the subject matter of any one or more of Examples 1-3 optionally include wherein the heater arrangement includes a first heater assembly and a second heater assembly.

In Example 5, the subject matter of Example 4 optionally includes wherein: the tube arrangement includes a first tube and a second tube, one or more of the thermal contact areas are configured to transfer heat between the first tube and the first heater assembly, one or more of the thermal contact areas are configured to transfer heat between the second tube and the second heater assembly, and the first tube includes the permeable material.

In Example 6, the subject matter of Example 5 optionally includes wherein the second tube is impermeable.

In Example 7, the subject matter of any one or more of Examples 5-6 optionally include wherein: the permeable material includes a first permeable material and a second permeable material, the first tube includes a first layer of the first permeable material, and the first tube includes a second layer of the second permeable material.

In Example 8, the subject matter of Example 7 optionally includes wherein a condensation layer is positioned between the first layer and the second layer.

In Example 9, the subject matter of any one or more of Examples 1-8 optionally include wherein the permeable material includes a sleeve positioned around coils of the tube arrangement.

In Example 10, the subject matter of any one or more of Examples 1-9 optionally include remaining in the liquid.

In Example 11, the subject matter of any one or more of Examples 1-10 optionally include remaining in the liquid.

In Example 12, the subject matter of any one or more of Examples 1-11 optionally include degrees Celsius of initial liquid temperature.

In Example 13, the subject matter of any one or more of Examples 1-12 optionally include degrees Celsius of initial liquid temperature.

In Example 14, the subject matter of any one or more of Examples 1-13 optionally include wherein the second end of the tube arrangement is included at a probe.

In Example 15, the subject matter of any one or more of Examples 1-14 optionally include wherein the second end of the tube arrangement is connected to a valve.

In Example 16, the subject matter of any one or more of Examples 1-15 optionally include wherein the second of the tube arrangement is connected to a probe.

In Example 17, the subject matter of any one or more of Examples 1-16 optionally include wherein the first end of the tube arrangement is connected to a pump.

In Example 18, the subject matter of any one or more of Examples 1-17 optionally include wherein the first of the tube arrangement is connected to a bottle.

In Example 19, the subject matter of any one or more of Examples 1-18 optionally include wherein at least a portion of the tube arrangement is helically wrapped about at least a portion of the heater arrangement.

In Example 20, the subject matter of Example 19 optionally includes a membrane positioned around at least a portion of the portion of the tube arrangement that is helically wrapped about at least the portion of the heater arrangement.

In Example 21, the subject matter of Example 20 optionally includes wherein the membrane is made of a material that is permeable to the gas dissolved in the liquid.

In Example 22, the subject matter of any one or more of Examples 1-21 optionally include wherein at least a portion of the permeable material of the tube arrangement comprises a silicone-based material.

In Example 23, the subject matter of any one or more of Examples 1-22 optionally include wherein at least a portion of the permeable material of the tube arrangement comprises a fluorinated ethylene propylene (FEP) material.

In Example 24, the subject matter of any one or more of Examples 1-23 optionally include wherein at least a portion of the permeable material of the tube arrangement comprises a perfluoroalkoxy alkane (PFA) material.

In Example 25, the subject matter of any one or more of Examples 2-24 optionally include wherein the first layer of the first permeable material provides geometric stability to the second layer of the second permeable material.

Example 26 is a dispenser for dispensing a liquid comprising a gas dissolved in the liquid, the dispenser comprising: a heater; and a first tube constructed of a first material, the first tube comprising a first end operable to be connected to a source of the liquid and a second end, the first tube connected to the heater via a conductive pathway thermally connecting the heater to the first tube, wherein, the first material has a permeability such that a portion of the gas dissolved in the liquid passes through the first material to an atmosphere upon being degassed from a portion of the liquid within the first tube.

In Example 27, the subject matter of Example 26 optionally includes a first heater block located in between the heater and the first tube forming a portion of the conductive pathway thermally joining the first heater and the first tube.

In Example 28, the subject matter of Example 27 optionally includes wherein the first heater block defines a groove, a majority of the first tube located at least partially in the groove.

In Example 29, the subject matter of Example 28 optionally includes wherein the groove is a helical groove and the first tube encircles the first heater block.

In Example 30, the subject matter of any one or more of Examples 27-29 optionally include a membrane that encircles the first heater block, the first tube located in between the membrane and the first heater block.

In Example 31, the subject matter of Example 30 optionally includes wherein the membrane is constructed of a material that is impermeable to the gas dissolved in the liquid.

In Example 32, the subject matter of any one or more of Examples 30-31 optionally include wherein the membrane is constructed of a material that is permeable to the gas dissolved in the liquid.

In Example 33, the subject matter of any one or more of Examples 26-32 optionally include wherein the permeability of the first material is a function of a thickness of the first material.

In Example 34, the subject matter of any one or more of Examples 26-33 optionally include wherein the material comprises a silicone based material.

In Example 35, the subject matter of any one or more of Examples 26-34 optionally include wherein the first material comprises a fluorinated ethylene propylene (FEP) material.

In Example 36, the subject matter of any one or more of Examples 26-35 optionally include wherein the first material comprises a perfluoroalkoxy alkane (PFA) material.

In Example 37, the subject matter of any one or more of Examples 26-36 optionally include a second tube arranged coaxial around the first tube to define an annular cavity.

In Example 38, the subject matter of Example 37 optionally includes wherein the second tube is impermeable to the gas dissolved in the liquid.

In Example 39, the subject matter of any one or more of Examples 37-38 optionally include wherein the second tube is permeable to the gas dissolved in the liquid.

In Example 40, the subject matter of any one or more of Examples 26-39 optionally include a second heater block in thermal communication with the first heater and comprising an interior surface defining a channel; and a second tube constructed of a second material, the second tube comprising a first end connected to the second end of the first tube and a second end in fluid communication with a dispensing nozzle, the second tube located at least partially within the channel, the second material being impermeable to the gas dissolved in the liquid.

In Example 41, the subject matter of any one or more of Examples 26-40 optionally include wherein the heater is configured to heat, via the conductive pathway, the liquid from a first temperature to a second temperature as the fluid traverses through the first tube and maintain a temperature of the fluid at about the second temperature while the fluid is stationary.

In Example 42, the subject matter of any one or more of Examples 26-41 optionally include a probe comprising: a second tube having a first end fluidly connected to the second end of the first tube; a dispensing nozzle connected to a second end of the second tube; and a thermally conductive material in thermal communication with the first heater block and that encircles a portion of the second tube.

In Example 43, the subject matter of any one or more of Examples 26-42 optionally include a temperature probe in thermal communication with at least one of the first heater block and the second heater block; and a controller in electrical communication with the temperature probe and the heater, and the second heater, the controller operable to perform actions comprising: continuously receiving a signal from the temperature probe, and regulating a temperature of the first heater block and the second heater block based on the signal.

In Example 44, the subject matter of any one or more of Examples 26-43 optionally include a temperature probe in thermal communication with the first heater block; and a controller in electrical communication with the temperature probe and the heater, the controller operable to perform actions comprising: continuously receiving a signal from the temperature probe, and regulating a temperature of the first heater block based on the signal.

In Example 45, the subject matter of any one or more of Examples 26-44 optionally include a shroud at least partially encircling the heater and the first tube, the shroud defining an opening sized to allow off gasses to escape to the atmosphere.

In Example 46, the subject matter of any one or more of Examples 26-45 optionally include a dispensing valve in fluid communication with the first tube.

In Example 47, the subject matter of any one or more of Examples 26-46 optionally include an aspirate valve; a first pressure probe configured to measure a system pressure within the dispenser; a second pressure probe configured to measure ambient pressure; and a controller in electrical communication with the first and second pressure probes, the dispensing valve and the aspirate valve, the controller operable to perform actions comprising: determine a pressure differential between the system pressure and the ambient pressure, and simultaneously open the aspirate valve and close the dispensing valve during a period of inactivity when the pressure differential exceeds a preset value.

In Example 48, the subject matter of any one or more of Examples 26-47 optionally include a pump connected to the first end of the first tube; and an aspirate valve connected to an inlet of the pump.

In Example 49, the subject matter of Example 48 optionally includes wherein the pump is a syringe pump.

In Example 50, the subject matter of any one or more of Examples 48-49 optionally include a bottle having an outlet in fluid communication with the aspirate valve.

Example 51 is a dispenser for dispensing a liquid comprising a gas dissolved in the liquid, the dispenser comprising: a heater; a first heater assembly comprising: a first tube constructed of a first material, the first tube comprising a first end operable to be connected to a source of the liquid and a second end, and a first heater block connected to the heater, the first heater block forming a conductive pathway from the heater to the first tube; and a second heater assembly comprising: a second heater block in thermal communication with the heater and comprising an interior surface defining a channel, and a second tube constructed of a second material, the second tube comprising a first end connected to the second end of the first tube and a second, the second tube located at least partially within the channel, wherein, the first material has a permeability such that the gas dissolved in the liquid passes through the first material to an atmosphere upon being degassed from a portion of the liquid within the first tube, wherein the second material is impermeable to the gas dissolved in the liquid.

In Example 52, the subject matter of Example 51 optionally includes wherein the first heater block defines a groove, a majority of the first tube located at least partially in the groove.

In Example 53, the subject matter of Example 52 optionally includes wherein the groove is a helical groove and the first tube encircles the first heater block.

In Example 54, the subject matter of any one or more of Examples 51-53 optionally include a membrane that encircles the first heater block, the first tube located in between the membrane and the first heater block.

In Example 55, the subject matter of Example 54 optionally includes wherein the membrane is constructed of a material that is impermeable to the gas dissolved in the liquid.

In Example 56, the subject matter of any one or more of Examples 54-55 optionally include wherein the membrane is constructed of a material that is permeable to the gas dissolved in the liquid.

In Example 57, the subject matter of any one or more of Examples 51-56 optionally include wherein the permeability of the first material is a function of a thickness of the first material.

In Example 58, the subject matter of any one or more of Examples 51-57 optionally include wherein the first material comprises a silicone based material.

In Example 59, the subject matter of any one or more of Examples 51-58 optionally include wherein the first material comprises a fluorinated ethylene propylene (FEP) material.

In Example 60, the subject matter of any one or more of Examples 51-59 optionally include wherein the first material comprises a perfluoroalkoxy alkane (PFA) material.

In Example 61, the subject matter of any one or more of Examples 51-60 optionally include a third tube arranged coaxial around the first tube to define an annular cavity.

In Example 62, the subject matter of Example 61 optionally includes wherein the third tube is impermeable to the gas dissolved in the liquid.

In Example 63, the subject matter of any one or more of Examples 61-62 optionally include wherein the third tube is permeable to the gas dissolved in the liquid.

In Example 64, the subject matter of any one or more of Examples 51-63 optionally include wherein the heater is configured to heat the liquid from a first temperature to a second temperature as the fluid traverses within the first tube and maintain a temperature of the fluid at about the second temperature while the fluid is stationary within the second tube.

In Example 65, the subject matter of any one or more of Examples 51-64 optionally include a probe comprising: a third tube having a first end fluidly connected to the second end of the second tube; a dispensing nozzle connected to a second end of the third tube; and a thermally conductive material in thermal communication with the second heater block and that encircles a portion of the third tube.

In Example 66, the subject matter of any one or more of Examples 51-65 optionally include a pump connected to the first end of the first tube; and an aspirate valve connected to an inlet of the pump.

In Example 67, the subject matter of Example 66 optionally includes wherein the pump is a syringe pump.

In Example 68, the subject matter of any one or more of Examples 66-67 optionally include a bottle having an outlet in fluid communication with the aspirate valve.

In Example 69, the subject matter of any one or more of Examples 51-68 optionally include a temperature probe in thermal communication with the first heater block and the second heater block; and a controller in electrical communication with the temperature probe and the heater, the controller operable to perform actions comprising: continuously receiving a signal from the temperature probe, and regulating a temperature of the first heater block and the second heater block based on the signal.

In Example 70, the subject matter of any one or more of Examples 51-69 optionally include a temperature probe in thermal communication with the first heater block; and a controller in electrical communication with the temperature probe and the heater, the controller operable to perform actions comprising: continuously receiving a signal from the temperature probe, and regulating a temperature of the first heater block based on the signal.

In Example 71, the subject matter of any one or more of Examples 51-70 optionally include a temperature probe in thermal communication with the second heater block; and a controller in electrical communication with the temperature probe and the second heater, the controller operable to perform actions comprising: continuously receiving a signal from the temperature probe, and regulating a temperature of the second heater block based on the signal.

In Example 72, the subject matter of any one or more of Examples 51-71 optionally include a shroud at least partially encircling the first heat block and the first tube, the shroud defining an opening sized to allow off gasses to escape to the atmosphere.

In Example 73, the subject matter of any one or more of Examples 51-72 optionally include a dispensing valve in fluid communication with the first tube.

In Example 74, the subject matter of Example 73 optionally includes an aspirate valve; a first pressure probe configured to measure a system pressure within the dispenser; a second pressure probe configured to measure ambient pressure; and a controller in electrical communication with the first and second pressure probes, the dispensing valve and the aspirate valve, the controller operable to perform actions comprising: determine a pressure differential between the system pressure and the ambient pressure, and simultaneously open the aspirate valve and close the dispensing valve during a period of inactivity when the pressure differential exceeds a preset value.

Example 75 is a dispenser for dispensing a liquid comprising a gas dissolved in the liquid, the dispenser comprising: a heater; a first heater assembly comprising: a first tube constructed of a first material, the first tube comprising a first operable to be connected to a source of the liquid and a second end, a second tube arranged coaxial around the first tube to define an annular cavity, the second constructed of a second material, and a first heater block connected to the heater, the first heater block forming a conductive pathway from the heater to the second tube; and a second heater assembly comprising: a second heater block in thermal communication with the heater and comprising an interior surface defining a channel, and a third tube constructed of a third material, the third tube comprising a first end connected to the second end of the first tube and a second end, the third tube located at least partially within the channel, wherein, the first material has a permeability such that the gas dissolved in the liquid passes through the first material to the annul cavity upon being degassed from a portion of the liquid within the first tube, wherein the third material is impermeable to the gas dissolved in the liquid.

In Example 76, the subject matter of Example 75 optionally includes wherein the first heater block defines a groove, a majority of the first tube and the second tube located at least partially in the groove.

In Example 77, the subject matter of Example 76 optionally includes wherein the groove is a helical groove and the first and second tubes encircles the first heater block.

In Example 78, the subject matter of any one or more of Examples 75-77 optionally include wherein the second material is impermeable to the gas dissolved in the liquid.

In Example 79, the subject matter of any one or more of Examples 75-78 optionally include wherein the second material is permeable to the gas dissolved in the liquid.

In Example 80, the subject matter of any one or more of Examples 75-79 optionally include wherein the permeability of the first material is a function of a thickness of the first material.

In Example 81, the subject matter of any one or more of Examples 75-80 optionally include wherein the second material is permeable to the gas dissolved in the liquid, and a permeability of the second material is a function of a thickness of the second material.

In Example 82, the subject matter of any one or more of Examples 75-81 optionally include wherein the first material comprises a silicone based material.

In Example 83, the subject matter of any one or more of Examples 75-82 optionally include wherein the second material comprises a silicone based material.

In Example 84, the subject matter of any one or more of Examples 75-83 optionally include wherein the first material comprises a fluorinated ethylene propylene (FEP) material.

In Example 85, the subject matter of any one or more of Examples 75-84 optionally include wherein the second material comprises a fluorinated ethylene propylene (FEP) material.

In Example 86, the subject matter of any one or more of Examples 75-85 optionally include wherein the first material comprises a perfluoroalkoxy alkane (PFA) material.

In Example 87, the subject matter of any one or more of Examples 75-86 optionally include wherein the second material comprises a perfluoroalkoxy alkane (PFA) material.

In Example 88, the subject matter of any one or more of Examples 75-87 optionally include wherein the heater is configured to heat the liquid from a first temperature to a second temperature as the fluid traverses within the first tube and maintain a temperature of the fluid at about the second temperature while the fluid is stationary within the third tube.

In Example 89, the subject matter of any one or more of Examples 75-88 optionally include a probe comprising: a fourth tube having a first end fluidly connected to the second end of the third tube; a dispensing nozzle connected to a second end of the fourth tube; and a thermally conductive material in thermal communication with the second heater block and that encircles a portion of the fourth tube.

In Example 90, the subject matter of any one or more of Examples 75-89 optionally include a pump connected to the first end of the first tube; and an aspirate valve connected to an inlet of the pump.

In Example 91, the subject matter of Example 90 optionally includes wherein the pump is a syringe pump.

In Example 92, the subject matter of any one or more of Examples 90-91 optionally include a bottle having an outlet in fluid communication with the aspirate valve.

In Example 93, the subject matter of any one or more of Examples 75-92 optionally include a temperature probe in thermal communication with the first heater block and the second heater block; a controller in electrical communication with the temperature probe and the heater, the controller operable to perform actions comprising: continuously receiving a signal from the temperature probe, and regulating a temperature of the first heater block and the second heater block based on the signal.

In Example 94, the subject matter of any one or more of Examples 75-93 optionally include a temperature probe in thermal communication with the first heater block; a controller in electrical communication with the temperature probe and the heater, the controller operable to perform actions comprising: continuously receiving a signal from the temperature probe, and regulating a temperature of the first heater block based on the signal.

In Example 95, the subject matter of any one or more of Examples 75-94 optionally include a temperature probe in thermal communication with the second heater block; a controller in electrical communication with the temperature probe and the second heater, the controller operable to perform actions comprising: continuously receiving a signal from the temperature probe, and regulating a temperature of the second heater block based on the signal.

In Example 96, the subject matter of any one or more of Examples 75-95 optionally include a shroud at least partially encircling the first heat block and the first and second tubes, the shroud defining an opening sized to allow off gasses to escape to the atmosphere.

In Example 97, the subject matter of any one or more of Examples 75-96 optionally include a membrane that encircles the first heater block, the first and second tubes located in between the membrane and the first heater block.

In Example 98, the subject matter of Example 97 optionally includes wherein the membrane is constructed of a material that is impermeable to the gas dissolved in the liquid.

In Example 99, the subject matter of any one or more of Examples 97-98 optionally include wherein the membrane is constructed of a material that is permeable to the gas dissolved in the liquid.

In Example 100, the subject matter of any one or more of Examples 75-99 optionally include a dispensing valve in fluid communication with the first tube.

In Example 101, the subject matter of Example 100 optionally includes an aspirate valve; a first pressure probe configured to measure a system pressure within the dispenser; a second pressure probe configured to measure ambient pressure; and a controller in electrical communication with the first and second pressure probes, the dispensing valve and the aspirate valve, the controller operable to perform actions comprising: determine a pressure differential between the system pressure and the ambient pressure, and simultaneously open the aspirate valve and close the dispensing valve during a period of inactivity when the pressure differential exceeds a preset value.

Example 102 is a dispenser for dispensing a liquid comprising a gas dissolved in the liquid, the dispenser comprising: a heater; a first heater assembly comprising: a first tube constructed of a first material, the first tube comprising a first end operable to be connected to a source of the liquid and a second end, a first heater block connected to the heater, the first heater block forming a conductive pathway from the heater to the second tube, and a membrane encircling the first heater block, the first tube located in between the membrane and the first heater block, the membrane, first heater block, and tube defining a cavity and an opening sized to allow off gasses to escape to the atmosphere; and a second heater assembly comprising: a second heater block in thermal communication with the heater and comprising an interior surface defining a channel, and a second tube constructed of a second material, the second tube comprising a first end connected to the second end of the first tube and a second end, the second tube located at least partially within the channel, wherein, the first material has a permeability such that the gas dissolved in the liquid passes through the first material to the cavity upon being degassed from a portion of the liquid within the first tube, wherein the third material is impermeable to the gas dissolved in the liquid.

In Example 103, the subject matter of Example 102 optionally includes wherein the first heater block defines a groove, a majority of the first tube located at least partially in the groove.

In Example 104, the subject matter of Example 103 optionally includes wherein the groove is a helical groove and the first tube encircles the first heater block.

In Example 105, the subject matter of any one or more of Examples 102-104 optionally include a third tube arranged coaxial around the first tube to define an annular cavity, the third tube constructed of a third material.

In Example 106, the subject matter of Example 105 optionally includes wherein the third material is impermeable to the gas dissolved in the liquid.

In Example 107, the subject matter of any one or more of Examples 105-106 optionally include wherein the third material is permeable to the gas dissolved in the liquid.

In Example 108, the subject matter of any one or more of Examples 105-107 optionally include wherein the permeability of the second material is a function of a thickness of the second material.

In Example 109, the subject matter of any one or more of Examples 102-108 optionally include wherein the permeability of the first material is a function of a thickness of the first material.

In Example 110, the subject matter of any one or more of Examples 102-109 optionally include wherein the first material comprises a silicone based material.

In Example 111, the subject matter of any one or more of Examples 102-110 optionally include wherein the first material comprises a fluorinated ethylene propylene (FEP) material.

In Example 112, the subject matter of any one or more of Examples 102-111 optionally include wherein the first material comprises a perfluoroalkoxy alkane (PFA) material.

In Example 113, the subject matter of any one or more of Examples 102-112 optionally include wherein the heater is configured to heat the liquid from a first temperature to a second temperature as the fluid traverses within the first tube and maintain a temperature of the fluid at about the second temperature while the fluid is stationary within the second tube.

In Example 114, the subject matter of any one or more of Examples 102-113 optionally include a probe comprising: a third tube having a first end fluidly connected to the second end of the second tube; a dispensing nozzle connected to a second end of the third tube; and a thermally conductive material in thermal communication with the second heater block and that encircles a portion of the third tube.

In Example 115, the subject matter of any one or more of Examples 102-114 optionally include a temperature probe in thermal communication with the first heater block and the second heater block; a controller in electrical communication with the temperature probe and the heater, the controller operable to perform actions comprising: continuously receiving a signal from the temperature probe, and regulating a temperature of the first heater block and the second heater block based on the signal.

In Example 116, the subject matter of any one or more of Examples 102-115 optionally include a temperature probe in thermal communication with the first heater block; a controller in electrical communication with the temperature probe and the heater, the controller operable to perform actions comprising: continuously receiving a signal from the temperature probe, and regulating a temperature of the first heater block based on the signal.

In Example 117, the subject matter of any one or more of Examples 102-116 optionally include a temperature probe in thermal communication with the second heater block; a controller in electrical communication with the temperature probe and the second heater, the controller operable to perform actions comprising: continuously receiving a signal from the temperature probe, and regulating a temperature of the second heater block based on the signal.

In Example 118, the subject matter of any one or more of Examples 102-117 optionally include a pump connected to the first end of the first tube; and an aspirate valve connected to an inlet of the pump.

In Example 119, the subject matter of Example 118 optionally includes wherein the pump is a syringe pump.

In Example 120, the subject matter of any one or more of Examples 118-119 optionally include a bottle having an outlet in fluid communication with the aspirate valve.

In Example 121, the subject matter of any one or more of Examples 102-120 optionally include wherein the membrane is constructed of a material that is impermeable to the gas dissolved in the liquid.

In Example 122, the subject matter of any one or more of Examples 102-121 optionally include wherein the membrane is constructed of a material that is permeable to the gas dissolved in the liquid.

In Example 123, the subject matter of any one or more of Examples 102-122 optionally include a dispensing valve in fluid communication with the first tube.

In Example 124, the subject matter of Example 123 optionally includes an aspirate valve; a first pressure probe configured to measure a system pressure within the dispenser; a second pressure probe configured to measure ambient pressure; and a controller in electrical communication with the first and second pressure probes, the dispensing valve and the aspirate valve, the controller operable to perform actions comprising: determine a pressure differential between the system pressure and the ambient pressure, and simultaneously open the aspirate valve and close the dispensing valve during a period of inactivity when the pressure differential exceeds a preset value.

Example 125 is a dispenser configured to dispense a liquid, to control temperature of the dispensed liquid, and to control dissolved gas in the dispensed liquid, the dispenser comprising: an inlet; an outlet; a first heater; a first tube extending along a length from a first end to a second end, the first tube configured for permeation of dissolved gas through a wall of the first tube; and an encapsulating arrangement configured to encapsulate the first tube over at least a portion of the length of the first tube, the encapsulating arrangement including a membrane configured for permeation of gas and containment of the liquid; and wherein the first end of the first tube is in at least selective fluid communication with the inlet, wherein the second end of the first tube is in at least selective fluid communication with the outlet, and thereby the first tube is configured to at least selectively transfer the liquid from the first end of the first tube to the second end of the first tube at least when the first tube is in fluid communication with the inlet and the outlet of the dispenser; wherein the first heater is configured to supply heat to the first tube and the first tube is configured to transfer at least a portion of the heat to the liquid within the first tube and thereby control the temperature of the dispensed liquid; and wherein the first tube and the membrane are configured to release dissolved gas from the liquid and thereby control dissolved gas in the dispensed liquid.

In Example 126, the subject matter of Example 125 optionally includes a temperature controller configured to control the first heater, the temperature controller comprising: a first temperature sensor configured to measure temperature (Th) of the first heater; a second temperature sensor configured to measure ambient temperature (Ta) near the dispensed liquid; a setpoint compensator configured to determine a setpoint temperature (S) based on the ambient temperature (Ta); and feedback circuitry configured to control the first heater based on a difference between the setpoint temperature (S) and the temperature (Th) of the first heater.

In Example 127, the subject matter of any one or more of Examples 125-126 optionally include a hollow probe extending from a first end to a second end, wherein the second end of the hollow probe includes the outlet of the dispenser.

In Example 128, the subject matter of any one or more of Examples 125-127 optionally include wherein the encapsulating arrangement includes an over-tube positioned co-axially around at least the portion of the length of the first tube and wherein the membrane that is configured for permeation of dissolved gas and for containment of the liquid is include in a wall of the over-tube.

In Example 129, the subject matter of any one or more of Examples 125-128 optionally include wherein the encapsulating arrangement includes an over-jacket positioned around at least the portion of the length of the first tube and around at least a portion of the first heater and wherein the membrane that is configured for permeation of dissolved gas and containment of the liquid is include in a wall of the over-jacket.

In Example 130, the subject matter of any one or more of Examples 125-129 optionally include wherein the first heater includes a body with at least one helical grove and wherein at least a portion of the first tube is positioned within the at least one helical grove.

In Example 131, the subject matter of any one or more of Examples 125-130 optionally include wherein the first tube includes silicone rubber.

In Example 132, the subject matter of any one or more of Examples 125-131 optionally include wherein the first tube includes cured silicone rubber.

In Example 133, the subject matter of any one or more of Examples 125-132 optionally include wherein the first tube includes PFA and/or a Teflon grade PFA.

In Example 134, the subject matter of any one or more of Examples 125-133 optionally include wherein the membrane includes fluorinated ethylene propylene (FEP).

In Example 135, the subject matter of any one or more of Examples 125-134 optionally include a humidity layer between the first tube and at least a portion of the encapsulating arrangement, wherein the humidity layer at least partially contains the liquid.

In Example 136, the subject matter of any one or more of Examples 125-135 optionally include wherein the first end of the first tube is in continuous fluid communication with the inlet and wherein the second end of the first tube is in continuous fluid communication with the outlet.

In Example 137, the subject matter of Example 136 optionally includes wherein the dispenser is configured for continuous dispensing.

In Example 138, the subject matter of any one or more of Examples 125-137 optionally include a valve between the first end of the first tube and the inlet and thereby the first end of the first tube is in selective fluid communication with the inlet.

In Example 139, the subject matter of any one or more of Examples 125-138 optionally include a valve between the second end of the first tube and the outlet and thereby the second end of the first tube is in selective fluid communication with the outlet.

In Example 140, the subject matter of any one or more of Examples 125-139 optionally include wherein the liquid includes an aqueous solution.

In Example 141, the subject matter of any one or more of Examples 125-140 optionally include wherein the liquid includes a substrate.

In Example 142, the subject matter of any one or more of Examples 125-141 optionally include wherein the dissolved gas includes dissolved oxygen (dO₂).

Example 143 is a method of dispensing a liquid, controlling a temperature of the dispensed liquid, and controlling an amount of dissolved gas within the dispensed liquid, the method comprising: providing a dispenser, the dispenser including: an inlet; an outlet; a first heater; a first tube extending along a length from a first end to a second end; and an encapsulating arrangement including a membrane, the encapsulating arrangement encapsulating the first tube over at least a portion of the length of the first tube; and transferring the liquid from the first end of the first tube to the outlet of the dispenser; providing heat with the first heater and thereby heating the first tube with the first heater and thereby heating the liquid within the first tube with the first heater; permeating dissolved gas through a wall of the first tube and thereby releasing dissolved gas from the liquid within the first tube; permeating gas through the membrane and thereby through the encapsulating arrangement; and containing the liquid within the encapsulating arrangement.

In Example 144, the subject matter of Example 143 optionally includes wherein providing heat with the first heater includes controlling the first heater, comprising: measuring temperature of the first heater; measuring ambient temperature near the dispensed liquid; determining a setpoint temperature based on the ambient temperature; and controlling the first heater based on a difference between the setpoint temperature and the temperature of the first heater.

In Example 145, the subject matter of any one or more of Examples 143-144 optionally include wherein the membrane is included in an over-tube that is positioned co-axially around the first tube.

Example 146 is a dispenser configured to dispense a liquid, to control temperature of the dispensed liquid, and to control dissolved gas in the dispensed liquid, the dispenser comprising: an inlet; an outlet; a first heater; and a first tube extending along a length from a first end to a second end, the first tube configured for permeation of dissolved gas through a wall of the first tube and further configured for containment of the liquid within the wall of the first tube; and wherein the first end of the first tube is in at least selective fluid communication with the inlet, wherein the second end of the first tube is in at least selective fluid communication with the outlet, and thereby the first tube is configured to at least selectively transfer the liquid from the first end of the first tube to the second end of the first tube at least when the first tube is in fluid communication with the inlet and the outlet of the dispenser; wherein the first heater is configured to supply heat to the first tube and the first tube is configured to transfer at least a portion of the heat to the liquid within the first tube and thereby control the temperature of the dispensed liquid; and wherein the first tube is configured to release dissolved gas from the liquid and thereby control dissolved gas in the dispensed liquid.

In Example 147, the dispensers, apparatuses, or method of any one or any combination of Examples 1-146 can optionally be configured such that all elements or options recited are available to use or select from.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

Unless defined otherwise, all technical and scientific terms used herein have the same meaning as commonly understood to one of ordinary skill in the art to which this disclosure belongs. In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A dispenser arrangement (100, 108, 200, 202, 300) configured to dispense a liquid (102) with a gas (102G) dissolved in the liquid, the dispenser comprising:
a tube arrangement (170, 270, 370) including permeable material and extending between a first end (124A, 130A, 132A, 134A) and a second end (122B, 124B, 128B); and
a heater arrangement (180, 280, 380) configured to transfer heat to the tube arrangement at one or more thermal contact areas (608),
wherein the tube arrangement is configured to:
transfer the liquid between the first and second ends of the tube arrangement,
transfer at least some of the heat to the liquid, and
degas the liquid by transferring at least some of the gas dissolved in the liquid through the permeable material.

2. The dispenser arrangement (100, 108, 200, 202, 300) of claim 1, wherein:
the tube arrangement (170, 270, 370) includes a tube (124),
the permeable material includes a first permeable material and a second permeable material,
the tube includes a first layer (704) of the first permeable material, and
the tube includes a second layer (712) of the second permeable material.

3. The dispenser arrangement (100, 108, 200, 202, 300) of claim 2, wherein a condensation layer (708) is positioned between the first layer and the second layer.

4. The dispenser arrangement (200, 202, 300) of claim 1, wherein the heater arrangement (280, 380) includes a first heater assembly (120) and a second heater assembly (204).

5. The dispenser arrangement (200, 202, 300) of claim 4, wherein:
the tube arrangement (270, 370) includes a first tube (124) and a second tube (206),
one or more of the thermal contact areas (608) are configured to transfer heat between the first tube and the first heater assembly,
one or more of the thermal contact areas (608) are configured to transfer heat between the second tube and the second heater assembly, and
the first tube includes the permeable material.

6. The dispenser arrangement (200, 202, 300) of claim 5, wherein the second tube is impermeable.

7. The dispenser arrangement (200, 202, 300) of claims 5 or 6, wherein:
the permeable material includes a first permeable material and a second permeable material,
the first tube includes a first layer (704) of the first permeable material, and
the first tube includes a second layer (712) of the second permeable material.

8. The dispenser arrangement (200, 202, 300) of claim 7, wherein a condensation layer (708) is positioned between the first layer and the second layer.

9. The dispenser arrangement (100, 108, 200, 202, 300) of any of the above claims, wherein the permeable material includes a sleeve (602) positioned around coils (150) of the tube arrangement.

10. The dispenser arrangement of any of the above claims, wherein transferring the at least some of the gas dissolved in the liquid through the permeable material results in 136±9 μM of dissolved O₂ remaining in the liquid.

11. The dispenser arrangement of any one of claims 1-9, wherein transferring the at least some of the gas dissolved in the liquid through the permeable material results in 210±18 μM of dissolved O₂ remaining in the liquid.

12. The dispenser arrangement of any one of claims 1-9, wherein transferring the at least some of the gas dissolved in the liquid through the permeable material results in a variation of ≤±6% in an RLU output over an operational boundary of 0.6274±5% atm pressure and 2±1 degrees Celsius of initial liquid temperature.

13. The dispenser arrangement of any one of claims 1-9, wherein transferring the at least some of the gas dissolved in the liquid through the permeable material results in a variation of ≤±6% in an RLU output over an operational boundary of 0.9668±5% atm pressure and 2±1 degrees Celsius of initial liquid temperature.

14. The dispenser arrangement (100, 108, 200, 202, 300) of any of the above claims, wherein the second end (122B) of the tube arrangement is included at a probe (122).

15. The dispenser arrangement (100, 108, 200, 202, 300) of any one of claims 1-13, wherein the second end (124B) of the tube arrangement is connected to a valve (126).

16. The dispenser arrangement (100, 108, 200, 202, 300) of any one of claims 1-13, wherein the second end (128B) of the tube arrangement is connected to a probe (122).

17. The dispenser arrangement (100, 108, 200, 202, 300) of any of the above claims, wherein the first end (130A) of the tube arrangement is connected to a pump (106).

18. The dispenser arrangement (100, 108, 200, 202, 300) of any of the above claims, wherein the first end (134A) of the tube arrangement is connected to a bottle (104).

19. The dispenser arrangement (100, 108, 200, 202, 300) of any of the above claims, wherein at least a portion of the tube arrangement is helically wrapped about at least a portion of the heater arrangement.

20. The dispenser arrangement (100, 108, 200, 202, 300) of claim 19, further comprising a membrane (362) positioned around at least a portion of the portion of the tube arrangement that is helically wrapped about at least the portion of the heater arrangement.

21. The dispenser arrangement (100, 108, 200, 202, 300) of claim 20, wherein the membrane is made of a material that is permeable to the gas dissolved in the liquid.

22. The dispenser arrangement (100, 108, 200, 202, 300) of any of the above claims, wherein at least a portion of the permeable material of the tube arrangement comprises a silicone-based material.

23. The dispenser arrangement (100, 108, 200, 202, 300) of any of the above claims, wherein at least a portion of the permeable material of the tube arrangement comprises a fluorinated ethylene propylene (FEP) material.

24. The dispenser arrangement (100, 108, 200, 202, 300) of any of the above claims, wherein at least a portion of the permeable material of the tube arrangement comprises a perfluoroalkoxy alkane (PFA) material.

25. The dispenser arrangement (100, 108, 200, 202, 300) of claim 2, wherein the first layer of the first permeable material provides geometric stability to the second layer of the second permeable material.

26. A dispenser (100, 200, 300) for dispensing a liquid (102) comprising a gas (102G) dissolved in the liquid, the dispenser comprising:
a heater (308); and
a first tube (124, 502) constructed of a first material, the first tube comprising a first end (124A) operable to be connected to a source (104) of the liquid and a second end (124B), the first tube connected to the heater via a conductive pathway thermally connecting the heater to the first tube,
wherein, the first material has a permeability such that a portion of the gas dissolved in the liquid passes through the first material to an atmosphere upon being degassed from a portion of the liquid within the first tube (124, 502).

27. The dispenser of claim 26, further comprising a first heater block (306) located in between the heater and the first tube forming a portion of the conductive pathway thermally joining the first heater and the first tube.

28. The dispenser of claim 27, wherein the first heater block defines a groove (404), a majority of the first tube located at least partially in the groove.

29. The dispenser of claim 28, wherein the groove is a helical groove and the first tube encircles the first heater block.

30. The dispenser of any one of claims 27-29, further comprising a membrane (362) that encircles the first heater block, the first tube located in between the membrane and the first heater block.

31. The dispenser of claim 30, wherein the membrane is constructed of a material that is impermeable to the gas dissolved in the liquid.

32. The dispenser of claim 30, wherein the membrane is constructed of a material that is permeable to the gas dissolved in the liquid.

33. The dispenser of any one of claims 26-32, wherein the permeability of the first material is a function of a thickness of the first material.

34. The dispenser of any one of claims 26-33, wherein the material comprises a silicone based material.

35. The dispenser of any one of claims 26-33, wherein the first material comprises a fluorinated ethylene propylene (FEP) material.

36. The dispenser of any one of claims 26-33, wherein the first material comprises a perfluoroalkoxy alkane (PFA) material.

37. The dispenser of any one of claims 26-33, further comprising a second tube (504) arranged coaxial around the first tube to define an annular cavity (506).

38. The dispenser of claim 37, wherein the second tube is impermeable to the gas dissolved in the liquid.

39. The dispenser of claim 37, wherein the second tube is permeable to the gas dissolved in the liquid.

40. The dispenser of any one of claims 26-39, further comprising:
a second heater block (306) in thermal communication with the first heater and comprising an interior surface (336) defining a channel (338); and
a second tube (128, 206, 342) constructed of a second material, the second tube comprising a first end (128A, 206A) connected to the second end of the first tube and a second end (128B, 206B) in fluid communication with a dispensing nozzle, the second tube located at least partially within the channel, the second material being impermeable to the gas dissolved in the liquid.

41. The dispenser of any one of claims 26-40, wherein the heater is configured to heat, via the conductive pathway, the liquid from a first temperature to a second temperature as the fluid traverses through the first tube and maintain a temperature of the fluid at about the second temperature while the fluid is stationary.

42. The dispenser of any one of claims 26-41, further comprising a probe (122) comprising:
a second tube (354) having a first end fluidly connected to the second end of the first tube;
a dispensing nozzle (358) connected to a second end of the second tube; and
a thermally conductive material (356) in thermal communication with the first heater block and that encircles a portion of the second tube.

43. The dispenser of any one of claims 26-42, further comprising:
a temperature probe (610, 914, 1002) in thermal communication with at least one of the first heater block and the second heater block, and
a controller (900, 1000, 1014) in electrical communication with the temperature probe and the heater, and the second heater, the controller operable to perform actions comprising:
continuously receiving a signal from the temperature probe, and
regulating a temperature of the first heater block and the second heater block based on the signal.

44. The dispenser of any one of claims 26-42, further comprising:
a temperature probe (610, 914, 1002) in thermal communication with the first heater block; and
a controller (900, 1000, 1014) in electrical communication with the temperature probe and the heater, the controller operable to perform actions comprising:
continuously receiving a signal from the temperature probe, and
regulating a temperature of the first heater block based on the signal.

45. The dispenser of any one of claims 26-44, further comprising a shroud (324) at least partially encircling the heater and the first tube, the shroud defining an opening sized to allow off gasses to escape to the atmosphere.

46. The dispenser of any one of claims 26-45, further comprising a dispensing valve (126) in fluid communication with the first tube.

47. The dispenser of any one of claims 26-46, further comprising:
an aspirate valve (114);
a first pressure probe (914) configured to measure a system pressure within the dispenser;
a second pressure probe (914) configured to measure ambient pressure; and
a controller (900) in electrical communication with the first and second pressure probes, the dispensing valve and the aspirate valve, the controller operable to perform actions comprising:
determine a pressure differential between the system pressure and the ambient pressure, and
simultaneously open the aspirate valve and close the dispensing valve during a period of inactivity when the pressure differential exceeds a preset value.

48. The dispenser of any one of claims 26-47, further comprising:
a pump (106) connected to the first end of the first tube; and
an aspirate valve (114) connected to an inlet of the pump.

49. The dispenser of claim 48, wherein the pump is a syringe pump.

50. The dispenser of claim 48, further comprising a bottle (104) having an outlet in fluid communication with the aspirate valve.

51. A dispenser (100, 200, 300) for dispensing a liquid (102) comprising a gas (102G) dissolved in the liquid, the dispenser comprising:
a heater (308);
a first heater assembly (120, 302) comprising:
a first tube (124, 502) constructed of a first material, the first tube comprising a first end (124A) operable to be connected to a source (104) of the liquid and a second end (124B), and
a first heater block (306) connected to the heater, the first heater block forming a conductive pathway from the heater to the first tube; and
a second heater assembly (204, 304) comprising:
a second heater block (330) in thermal communication with the heater and comprising an interior surface (336) defining a channel (338), and
a second tube (128, 206, 342) constructed of a second material, the second tube comprising a first end (128A, 206A) connected to the second end of the first tube and a second end (128B, 206B), the second tube located at least partially within the channel,
wherein, the first material has a permeability such that the gas dissolved in the liquid passes through the first material to an atmosphere upon being degassed from a portion of the liquid within the first tube,
wherein the second material is impermeable to the gas dissolved in the liquid.

52. The dispenser of claim 51, wherein the first heater block defines a groove (404), a majority of the first tube located at least partially in the groove.

53. The dispenser of claim 52, wherein the groove is a helical groove and the first tube encircles the first heater block.

54. The dispenser of any one of claims 51-53, further comprising a membrane (362) that encircles the first heater block, the first tube located in between the membrane and the first heater block.

55. The dispenser of claim 54, wherein the membrane is constructed of a material that is impermeable to the gas dissolved in the liquid.

56. The dispenser of claim 54, wherein the membrane is constructed of a material that is permeable to the gas dissolved in the liquid.

57. The dispenser of any one of claims 51-56, wherein the permeability of the first material is a function of a thickness of the first material.

58. The dispenser of any one of claims 51-57, wherein the first material comprises a silicone based material.

59. The dispenser of any one of claims 51-57, wherein the first material comprises a fluorinated ethylene propylene (FEP) material.

60. The dispenser of any one of claims 51-57, wherein the first material comprises a perfluoroalkoxy alkane (PFA) material.

61. The dispenser of any one of claims 51-60, further comprising a third tube (504) arranged coaxial around the first tube to define an annular cavity (508).

62. The dispenser of claim 61, wherein the third tube is impermeable to the gas dissolved in the liquid.

63. The dispenser of claim 61, wherein the third tube is permeable to the gas dissolved in the liquid.

64. The dispenser of any one of claims 51-63, wherein the heater is configured to heat the liquid from a first temperature to a second temperature as the fluid traverses within the first tube and maintain a temperature of the fluid at about the second temperature while the fluid is stationary within the second tube.

65. The dispenser of any one of claims 51-64, further comprising a probe (122) comprising:
a third tube (354) having a first end fluidly connected to the second end of the second tube;
a dispensing nozzle (358) connected to a second end of the third tube; and
a thermally conductive material (356) in thermal communication with the second heater block and that encircles a portion of the third tube.

66. The dispenser of any one of claims 51-65, further comprising:
a pump (106) connected to the first end of the first tube; and
an aspirate valve (114) connected to an inlet of the pump.

67. The dispenser of claim 66, wherein the pump is a syringe pump.

68. The dispenser of claim 66, further comprising a bottle (104) having an outlet in fluid communication with the aspirate valve.

69. The dispenser of any one of claims 51-68, further comprising:
a temperature probe (610, 914, 1002) in thermal communication with the first heater block and the second heater block; and
a controller (900, 1000, 1014) in electrical communication with the temperature probe and the heater, the controller operable to perform actions comprising:
continuously receiving a signal from the temperature probe, and
regulating a temperature of the first heater block and the second heater block based on the signal.

70. The dispenser of any one of claims 51-69, further comprising:
a temperature probe (610, 914, 1002) in thermal communication with the first heater block; and
a controller (900, 1000, 1014) in electrical communication with the temperature probe and the heater, the controller operable to perform actions comprising:
continuously receiving a signal from the temperature probe, and
regulating a temperature of the first heater block based on the signal.

71. The dispenser of any one of claims 51-70, further comprising:
a temperature probe (610, 914, 1002) in thermal communication with the second heater block; and
a controller (900, 1000, 1014) in electrical communication with the temperature probe and the second heater, the controller operable to perform actions comprising:
continuously receiving a signal from the temperature probe, and
regulating a temperature of the second heater block based on the signal.

72. The dispenser of any one of claims 51-71, further comprising a shroud (324) at least partially encircling the first heat block and the first tube, the shroud defining an opening sized to allow off gasses to escape to the atmosphere.

73. The dispenser of any one of claims 51-72, further comprising a dispensing valve (126) in fluid communication with the first tube.

74. The dispenser of claim 73, further comprising:
an aspirate valve (114);
a first pressure probe (914) configured to measure a system pressure within the dispenser;
a second pressure probe (914) configured to measure ambient pressure; and
a controller (900) in electrical communication with the first and second pressure probes, the dispensing valve and the aspirate valve, the controller operable to perform actions comprising:
determine a pressure differential between the system pressure and the ambient pressure, and
simultaneously open the aspirate valve and close the dispensing valve during a period of inactivity when the pressure differential exceeds a preset value.

75. A dispenser (100, 200, 300) for dispensing a liquid (102) comprising a gas (102G) dissolved in the liquid, the dispenser comprising:
a heater (308);
a first heater assembly (120, 302) comprising:
a first tube (124, 502) constructed of a first material, the first tube comprising a first end (124A) operable to be connected to a source of the liquid and a second end (124B),
a second tube (504) arranged coaxial around the first tube to define an annular cavity (506), the second constructed of a second material, and
a first heater block (306) connected to the heater, the first heater block forming a conductive pathway from the heater to the second tube; and
a second heater assembly (204, 304) comprising:
a second heater block (330) in thermal communication with the heater and comprising an interior surface (336) defining a channel (338), and
a third tube (128, 206, 342) constructed of a third material, the third tube comprising a first end (128A, 206A) connected to the second end of the first tube and a second end (128B, 206B), the third tube located at least partially within the channel,
wherein, the first material has a permeability such that the gas dissolved in the liquid passes through the first material to the annul cavity upon being degassed from a portion of the liquid within the first tube,
wherein the third material is impermeable to the gas dissolved in the liquid.

76. The dispenser of claim 75, wherein the first heater block defines a groove (404), a majority of the first tube and the second tube located at least partially in the groove.

77. The dispenser of claim 76, wherein the groove is a helical groove and the first and second tubes encircles the first heater block.

78. The dispenser of any one of claims 75-77, wherein the second material is impermeable to the gas dissolved in the liquid.

79. The dispenser of any one of claims 75-77, wherein the second material is permeable to the gas dissolved in the liquid.

80. The dispenser of any one of claims 75-79, wherein the permeability of the first material is a function of a thickness of the first material.

81. The dispenser of any one of claims 75-80, wherein
the second material is permeable to the gas dissolved in the liquid, and
a permeability of the second material is a function of a thickness of the second material.

82. The dispenser of any one of claims 75-81, wherein the first material comprises a silicone based material.

83. The dispenser of any one of claims 75-82, wherein the second material comprises a silicone based material.

84. The dispenser of any one of claims 75-81, wherein the first material comprises a fluorinated ethylene propylene (FEP) material.

85. The dispenser of any one of claims 75-81 or 84, wherein the second material comprises a fluorinated ethylene propylene (FEP) material.

86. The dispenser of any one of claims 75-81, wherein the first material comprises a perfluoroalkoxy alkane (PFA) material.

87. The dispenser of any one of claims 75-81 or 86, wherein the second material comprises a perfluoroalkoxy alkane (PFA) material.

88. The dispenser of any one of claims 75-87, wherein the heater is configured to heat the liquid from a first temperature to a second temperature as the fluid traverses within the first tube and maintain a temperature of the fluid at about the second temperature while the fluid is stationary within the third tube.

89. The dispenser of any one of claims 75-88, further comprising a probe (122) comprising:
a fourth tube (354) having a first end fluidly connected to the second end of the third tube;
a dispensing nozzle (358) connected to a second end of the fourth tube; and
a thermally conductive material (356) in thermal communication with the second heater block and that encircles a portion of the fourth tube.

90. The dispenser of any one of claims 75-89, further comprising:
a pump (106) connected to the first end of the first tube; and
an aspirate valve (114) connected to an inlet of the pump.

91. The dispenser of claim 90, wherein the pump is a syringe pump.

92. The dispenser of claim 90, further comprising a bottle (104) having an outlet in fluid communication with the aspirate valve.

93. The dispenser of any one of claims 75-92, further comprising:
a temperature probe (610, 914, 1002) in thermal communication with the first heater block and the second heater block;
a controller (900, 1000, 1014) in electrical communication with the temperature probe and the heater, the controller operable to perform actions comprising:
continuously receiving a signal from the temperature probe, and
regulating a temperature of the first heater block and the second heater block based on the signal.

94. The dispenser of any one of claims 75-92, further comprising:
a temperature probe (610, 914, 1002) in thermal communication with the first heater block;
a controller (900, 1000, 1014) in electrical communication with the temperature probe and the heater, the controller operable to perform actions comprising:
continuously receiving a signal from the temperature probe, and
regulating a temperature of the first heater block based on the signal.

95. The dispenser of any one of claims 75-92, further comprising:
a temperature probe (610, 914, 1002) in thermal communication with the second heater block;
a controller (900, 1000, 1014) in electrical communication with the temperature probe and the second heater, the controller operable to perform actions comprising:
continuously receiving a signal from the temperature probe, and
regulating a temperature of the second heater block based on the signal.

96. The dispenser of any one of claims 75-95, further comprising a shroud (324) at least partially encircling the first heat block and the first and second tubes, the shroud defining an opening sized to allow off gasses to escape to the atmosphere.

97. The dispenser of any one of claims 75-96, further comprising a membrane (362) that encircles the first heater block, the first and second tubes located in between the membrane and the first heater block.

98. The dispenser of claim 97, wherein the membrane is constructed of a material that is impermeable to the gas dissolved in the liquid.

99. The dispenser of claim 97, wherein the membrane is constructed of a material that is permeable to the gas dissolved in the liquid.

100. The dispenser of any one of claims 75-99, further comprising a dispensing valve (126) in fluid communication with the first tube.

101. The dispenser of claim 100, further comprising:
an aspirate valve (114);
a first pressure probe (914) configured to measure a system pressure within the dispenser;
a second pressure probe (914) configured to measure ambient pressure; and
a controller (900) in electrical communication with the first and second pressure probes, the dispensing valve and the aspirate valve, the controller operable to perform actions comprising:
determine a pressure differential between the system pressure and the ambient pressure, and
simultaneously open the aspirate valve and close the dispensing valve during a period of inactivity when the pressure differential exceeds a preset value.

102. A dispenser (100, 200, 300) for dispensing a liquid (102) comprising a gas (102G) dissolved in the liquid, the dispenser comprising:
a heater (308);
a first heater assembly (120, 302) comprising:
a first tube (124, 502) constructed of a first material, the first tube comprising a first end (124A) operable to be connected to a source of the liquid and a second end (124B),
a first heater block (306) connected to the heater, the first heater block forming a conductive pathway from the heater to the second tube, and
a membrane (362) encircling the first heater block, the first tube located in between the membrane and the first heater block, the membrane, first heater block, and tube defining a cavity (604) and an opening sized to allow off gasses to escape to the atmosphere; and
a second heater assembly (204, 304) comprising:
a second heater block (330) in thermal communication with the heater and comprising an interior surface (336) defining a channel (338), and
a second tube (128, 206, 342) constructed of a second material, the second tube comprising a first end (128A, 206A) connected to the second end of the first tube and a second end (128B, 206B), the second tube located at least partially within the channel,
wherein, the first material has a permeability such that the gas dissolved in the liquid passes through the first material to the cavity upon being degassed from a portion of the liquid within the first tube,
wherein the third material is impermeable to the gas dissolved in the liquid.

103. The dispenser of claim 102, wherein the first heater block defines a groove (404), a majority of the first tube located at least partially in the groove.

104. The dispenser of claim 103, wherein the groove is a helical groove and the first tube encircles the first heater block.

105. The dispenser of any one of claims 102-104, further comprising a third tube (504) arranged coaxial around the first tube to define an annular cavity (506), the third tube constructed of a third material.

106. The dispenser of claim 105, wherein the third material is impermeable to the gas dissolved in the liquid.

107. The dispenser of claim 105, wherein the third material is permeable to the gas dissolved in the liquid.

108. The dispenser of claim 105, wherein the permeability of the second material is a function of a thickness of the second material.

109. The dispenser of any one of claims 102-108, wherein the permeability of the first material is a function of a thickness of the first material.

110. The dispenser of any one of claims 102-109, wherein the first material comprises a silicone based material.

111. The dispenser of any one of claims 102-109, wherein the first material comprises a fluorinated ethylene propylene (FEP) material.

112. The dispenser of any one of claims 102-109, wherein the first material comprises a perfluoroalkoxy alkane (PFA) material.

113. The dispenser of any one of claims 102-112, wherein the heater is configured to heat the liquid from a first temperature to a second temperature as the fluid traverses within the first tube and maintain a temperature of the fluid at about the second temperature while the fluid is stationary within the second tube.

114. The dispenser of any one of claims 102-113, further comprising a probe (122) comprising:
a third tube (354) having a first end fluidly connected to the second end of the second tube;
a dispensing nozzle (358) connected to a second end of the third tube; and
a thermally conductive material (356) in thermal communication with the second heater block and that encircles a portion of the third tube.

115. The dispenser of any one of claims 102-114, further comprising:
a temperature probe (610, 914, 1002) in thermal communication with the first heater block and the second heater block;
a controller (900, 1000, 1014) in electrical communication with the temperature probe and the heater, the controller operable to perform actions comprising:
continuously receiving a signal from the temperature probe, and
regulating a temperature of the first heater block and the second heater block based on the signal.

116. The dispenser of any one of claims 102-114, further comprising:
a temperature probe (610, 914, 1002) in thermal communication with the first heater block;
a controller (900, 1000, 1014) in electrical communication with the temperature probe and the heater, the controller operable to perform actions comprising:
continuously receiving a signal from the temperature probe, and
regulating a temperature of the first heater block based on the signal.

117. The dispenser of any one of claims 102-114, further comprising:
a temperature probe (610, 914, 1002) in thermal communication with the second heater block;
a controller (900, 1000, 1014) in electrical communication with the temperature probe and the second heater, the controller operable to perform actions comprising:
continuously receiving a signal from the temperature probe, and
regulating a temperature of the second heater block based on the signal.

118. The dispenser of any one of claims 102-117, further comprising:
a pump (106) connected to the first end of the first tube; and
an aspirate valve (114) connected to an inlet of the pump.

119. The dispenser of claim 118, wherein the pump is a syringe pump.

120. The dispenser of claim 118, further comprising a bottle (104) having an outlet in fluid communication with the aspirate valve.

121. The dispenser of any one of claims 102-120, wherein the membrane is constructed of a material that is impermeable to the gas dissolved in the liquid.

122. The dispenser of any one of claims 102-120, wherein the membrane is constructed of a material that is permeable to the gas dissolved in the liquid.

123. The dispenser of any one of claims 102-122, further comprising a dispensing valve (126) in fluid communication with the first tube.

124. The dispenser of claim 123, further comprising:
an aspirate valve (114);
a first pressure probe (914) configured to measure a system pressure within the dispenser;
a second pressure probe (914) configured to measure ambient pressure; and
a controller (900) in electrical communication with the first and second pressure probes, the dispensing valve and the aspirate valve, the controller operable to perform actions comprising:
determine a pressure differential between the system pressure and the ambient pressure, and
simultaneously open the aspirate valve and close the dispensing valve during a period of inactivity when the pressure differential exceeds a preset value.

125. A dispenser (100, 200, 300) configured to dispense a liquid (102), to control temperature of the dispensed liquid, and to control dissolved gas in the dispensed liquid, the dispenser comprising:
an inlet (124A);
an outlet (358);
a first heater (308);
a first tube (502) extending along a length from a first end to a second end, the first tube configured for permeation of dissolved gas through a wall of the first tube; and
an encapsulating arrangement (504, 362) configured to encapsulate the first tube over at least a portion of the length of the first tube, the encapsulating arrangement including a membrane configured for permeation of gas and containment of the liquid; and
wherein the first end of the first tube is in at least selective fluid communication with the inlet, wherein the second end of the first tube is in at least selective fluid communication with the outlet, and thereby the first tube is configured to at least selectively transfer the liquid from the first end of the first tube to the second end of the first tube at least when the first tube is in fluid communication with the inlet and the outlet of the dispenser;
wherein the first heater is configured to supply heat to the first tube and the first tube is configured to transfer at least a portion of the heat to the liquid within the first tube and thereby control the temperature of the dispensed liquid; and
wherein the first tube and the membrane are configured to release dissolved gas from the liquid and thereby control dissolved gas in the dispensed liquid.

126. The dispenser of claim 125, further comprising a temperature controller (1000, 1014) configured to control the first heater, the temperature controller comprising:
a first temperature sensor (1002) configured to measure temperature (Tₕ) of the first heater;
a second temperature sensor (1006) configured to measure ambient temperature (Tₐ) near the dispensed liquid;
a setpoint compensator (1008) configured to determine a setpoint temperature (S) based on the ambient temperature (Tₐ); and
feedback circuitry (1012) configured to control the first heater based on a difference between the setpoint temperature (S) and the temperature (Tₕ) of the first heater.

127. The dispenser of any one of claims 125 or 126, further comprising a hollow probe (122) extending from a first end to a second end, wherein the second end of the hollow probe includes the outlet of the dispenser.

128. The dispenser of any one of claims 125-127, wherein the encapsulating arrangement includes an over-tube (504) positioned co-axially around at least the portion of the length of the first tube and wherein the membrane that is configured for permeation of dissolved gas and for containment of the liquid is include in a wall of the over-tube.

129. The dispenser of any one of claims 125-127, wherein the encapsulating arrangement includes an over-jacket (504) positioned around at least the portion of the length of the first tube and around at least a portion of the first heater and wherein the membrane that is configured for permeation of dissolved gas and containment of the liquid is include in a wall of the over-jacket.

130. The dispenser of any of claims 125-129, wherein the first heater includes a body (208) with at least one helical grove (404) and wherein at least a portion of the first tube is positioned within the at least one helical grove.

131. The dispenser of any of claims 125-130, wherein the first tube includes silicone rubber.

132. The dispenser of any of claims 125-130, wherein the first tube includes cured silicone rubber.

133. The dispenser of any of claims 125-130, wherein the first tube includes PFA and/or a Teflon grade PFA.

134. The dispenser of any of claims 125-133, wherein the membrane includes fluorinated ethylene propylene (FEP).

135. The dispenser of any of claims 125-134, further comprising a humidity layer (708) between the first tube and at least a portion of the encapsulating arrangement, wherein the humidity layer at least partially contains the liquid.

136. The dispenser of any of claims 125-135, wherein the first end of the first tube is in continuous fluid communication with the inlet and wherein the second end of the first tube is in continuous fluid communication with the outlet.

137. The dispenser of claim 136, wherein the dispenser is configured for continuous dispensing.

138. The dispenser of any of claims 125-137, further comprising a valve (114) between the first end of the first tube and the inlet and thereby the first end of the first tube is in selective fluid communication with the inlet.

139. The dispenser of any of claims 125-135, further comprising a valve (126) between the second end of the first tube and the outlet and thereby the second end of the first tube is in selective fluid communication with the outlet.

140. The dispenser of any of claims 125-139, wherein the liquid includes an aqueous solution.

141. The dispenser of any of claims 125-140, wherein the liquid includes a substrate.

142. The dispenser of any of claims 125-141, wherein the dissolved gas includes dissolved oxygen (dO₂).

143. A method of dispensing a liquid (102), controlling a temperature of the dispensed liquid, and controlling an amount of dissolved gas within the dispensed liquid, the method comprising:
providing a dispenser (100, 200, 300), the dispenser including:
an inlet (124A);
an outlet (358);
a first heater (308);
a first tube (502) extending along a length from a first end to a second end; and
an encapsulating arrangement (504, 362) including a membrane, the encapsulating arrangement encapsulating the first tube over at least a portion of the length of the first tube; and
transferring the liquid from the first end of the first tube to the outlet of the dispenser;
providing heat with the first heater and thereby heating the first tube with the first heater and thereby heating the liquid within the first tube with the first heater;
permeating dissolved gas through a wall of the first tube and thereby releasing dissolved gas from the liquid within the first tube;
permeating gas through the membrane and thereby through the encapsulating arrangement; and
containing the liquid within the encapsulating arrangement.

144. The method of claim 143, wherein providing heat with the first heater includes controlling the first heater, comprising:
measuring temperature of the first heater;
measuring ambient temperature near the dispensed liquid;
determining a setpoint temperature based on the ambient temperature; and
controlling the first heater based on a difference between the setpoint temperature and the temperature of the first heater.

145. The method of claim 143, wherein the membrane is included in an over-tube (504) that is positioned co-axially around the first tube.

146. A dispenser (100, 200, 300) configured to dispense a liquid (102), to control temperature of the dispensed liquid, and to control dissolved gas in the dispensed liquid, the dispenser comprising:
an inlet (124A);
an outlet (358);
a first heater (308); and
a first tube (502) extending along a length from a first end to a second end, the first tube configured for permeation of dissolved gas through a wall of the first tube and further configured for containment of the liquid within the wall of the first tube; and
wherein the first end of the first tube is in at least selective fluid communication with the inlet, wherein the second end of the first tube is in at least selective fluid communication with the outlet, and thereby the first tube is configured to at least selectively transfer the liquid from the first end of the first tube to the second end of the first tube at least when the first tube is in fluid communication with the inlet and the outlet of the dispenser;
wherein the first heater is configured to supply heat to the first tube and the first tube is configured to transfer at least a portion of the heat to the liquid within the first tube and thereby control the temperature of the dispensed liquid; and
wherein the first tube is configured to release dissolved gas from the liquid and thereby control dissolved gas in the dispensed liquid.
